(19) United States
(12) Patent Application Publication
(10) Pub. No.: US 2002/0052913 A1
(43) Pub. Date: May 2, 2002

(54) User support apparatus and system using agents

(76) Inventors: Teruhiro Yamada, Osaka (JP); Mutsumi Ikeda, Saitama (JP); Atsushi Maeda, Osaka (JP); Tsugufumi Matsuoka, Osaka (JP)

Correspondence Address: LYON & LYON LLP, 633 WEST FIFTH STREET, SUITE 4700, LOS ANGELES, CA, 90071, US

(21) Appl. No.: 09/822,798

(22) Filed: Mar. 30, 2001

(30) Foreign Application Priority Data
Sep. 6, 2000 (JP) A 2000-270845
Nov. 29, 2000 (JP) A 2000-362400
Sep. 21, 2000 (JP) A 2000-287615
Dec. 4, 2000 (JP) A 2000-369116
Dec. 21, 2000 (JP) A 2000-389638

(51) Int. Cl. G06F 15/16

(52) U.S. Cl. 709/202

(57) ABSTRACT

A user support function is realized in a user terminal. The function may be implemented in the user terminal or sent from a server. The function helps the user using characters activated by agent programs. Each character has a specific area to cover as an expert. When the user needs restaurant information, a “gourmet” character appears on the screen to respond to the user request. The character analyzes the user request through text search.

### BACKGROUND OF THE INVENTION

1. Field of the Invention

The present invention relates to a technique for supporting users in an electronic manner. This invention particularly relates to an apparatus and a system for supporting users by providing information necessary for the users employing agents.

2. Description of the Related Art

Since the Internet access at home has been common recently, WWW (World Wide Web) users are growing rapidly. As it is convenient for the users at home to access to a huge amount of information from all over the world, the number of users is further increasing.

Now users can believe that almost all the necessary information exists somewhere in the huge number of web sites. The number of web sites or pages, however, has become too large for users to reach the information they need although they know that the information exists somewhere in the web sites.

Portal sites with search engines who are aware of the above situation have been trying hard to sophisticate search methods by, for example, making information hierarchical with the help of the portal sites, users can efficiently find necessary information out of the flood of information using search conditions or formulas including logical OR and logical AND in each topic area predefined by the portal sites.

It becomes, however, extremely difficult for general users to use highly complicated and logical search formulas in today's environment where most of the web population is beginners. The problem is becoming to be more difficult as the hierarchy of information becomes deeper, and the classification of information is complicated to be instantly understood. The amount of information will spoil the utilization of information as the number of sites is still increasing, and more and more beginners are coming in the web world.

It is therefore an object of the present invention to help users reach information they need in a friendly virtual environment. It is another object of the present invention to provide a technique for supporting users to smoothly conduct operations in computers and other devices.

### SUMMARY OF THE INVENTION

According to one aspect of the present invention, a user support apparatus is provided. The apparatus comprises an agent storage and an agent output unit. The agent storage stores data of a first agent being dedicated to a user serving based on information of the user and data of a second agent being an expert of a specific area, whereas the agent output unit outputs the first and second agents derived from said data visually or audibly to the user.

In this configuration, the first agent gives a selection guide to the second agent when the second agent selects information necessary for providing the service. The process of giving the guide is conducted visibly from the user.

The first agent therefore reduces user operation as it acts on the second agent for the user. Another advantage is that the user can understand that the direction of the job being done by the second agent.

The process of giving the guide is realized just for showing it to the user. It is therefore not necessary for the first agent to actually give the guide to the second agent inside the apparatus. System designers can easily understand it more convenient to provide or design an agent manager to manage the first and second agents collectively instead of designing the two agents independently. In this sense, the agent manager controls the first agent and second agent as “puppets” inside the apparatus and the guide given from the first agent to the second agent is controlled by the agent manager outputting images and/or audio data to the user. Even such a case is, however, described as “the first agent gives a guide to the second agent” in this specification.

The apparatus may further comprise an interface through which the user inputs an instruction. The second agent may select the information putting higher priority on the inputted instruction than the given or presented guide from the first agent. In this configuration, the user can modify, cancel or change the guide given by the first agent, as he/she wants. The interface may comprise a user interface by which the user can input necessary instructions and a request inputting unit provided in the agent manager for accepting requests from the user.

According to another aspect of the present invention, a user support apparatus is provided. The apparatus comprises a front processor which works at a user interface level and a middle processor which handles and stores data to be presented to the user via the front processor. The front processor comprises an agent storage which stores the data of a first agent being dedicated to the user serving based on information of the user and data of a second agent being an expert of a specific area. The first and second agents are designed in such a manner that the first agent, when the second agent requests the middle processor provide information necessary to serve the user, presents a selection guide to the second agent based on the user information in the manner that the user can recognize the presentation of the guide.

The front processor may have a functional block to make the user interact with the apparatus, realized by software, hardware or any combinations of the two. In this configuration, the middle processor serves for the user as an information accumulator and manager, and can provide information necessary for the user more efficiently in general. “The middle processor” does not necessary assume the existence of a back processor or any other processors.

According to still another aspect of the present invention, a user support apparatus is provided. The apparatus comprises a front processor which works at user interface level and a back processor which acquires data to be presented to the user from outside. The back processor may comprise an agent providing unit which sends said data to the agent storage. In this configuration, also the first and second agents collaborate in an aforementioned manner. The back processor may acquire the latest agent data and information necessary for the user from, for example, arbitrary web sites connected to the Internet. Here, the “back processor” does not necessary assume the existence of the middle processor or any other processors.

The back processor may function as a server for serving the agent data to the front processor via the Internet or any other networks. The server can be configured in various manners such that the main functions remain at a server side like CGI or Common Gateway Interface, the main functions are transferred to the client side like a Java (trademark) applet or Active X (trademark), and an API or Application Program Interface type where the main functions are provided at both the server and client sides like a Java application.

In this configuration, the agent storage may store a local agent which has existed in the front processor without provided from the back processor and a remote agent which has come to exist provided from the back processor. The local agent is convenient in that it is generally easily customized in each apparatus and is available even when the apparatus is in an off-line state. The remote agent on the other hand is convenient in that it can be sent from the user to a plurality of apparatuses and is generally easily updated or registered at the server end. The local agent and remote agent may be provided to the user in such a manner that the user cannot distinguish them so that a seamless environment may be provided.

According to still another aspect of the present invention, a user support apparatus is provided. The apparatus comprises memory, program modules loaded on the memory and a CPU to execute the modules which may include functions of executing a first agent and a second agent, the first agent being represented as a character to bridge the user and the apparatus and to serve the user in a user-dependent manner based on information of the user, and the second agent being represented as a character to bridge the user and the apparatus and to serve the user for a specific area as an expert thereof. In this configuration, the first agent, when the second agent selects information necessary to serve the user, presents a selection guide to the second agent based on the user information whereby the user can recognize the presentation of the guide.

According to still another aspect of the present invention, a user support apparatus is provided. The apparatus comprises an agent storage which stores data of a first agent and a second agent which bridge a user and the apparatus and an agent outputs unit which outputs the first and second agents derived from said data. The first and second agents are so designed to collaborate while having conversion or dialog recognizable from the user when the user requests a given or arbitrary service. The conversation may show the process to optimize the service for the user. The user can understand the process from the conversation.

According to any one of the aforementioned aspects, a user-friendly agent can let the user know the processes conducted in the apparatus so that the user can judge the processes are correctly performed for him/her.

The middle processor may comprise a meta information generator which generates meta information by analyzing a page which is a collective of data necessary for the user and which is provided from the back processor, and a write controller which stores the page and the meta information in a local memory device by associating them. “Meta information” corresponds to the information with regard to the page after “meta data” meaning “data with regard to data”.

In this configuration, the page and meta information are combined, one being embedded in another or the two being linked to be associated with. The combination is then stored in a local memory device. The user can roughly understand or search the content or subject of the page using the meta information. The page can be retrieved from the local memory generally faster than a global search as long as the page exists in the local memory or a cache memory.

The meta information generator may further comprise a keyword detector to detect keywords in the page, a subject analyzer to analyze the subject intention, purpose or theme of the page, and a meta information extractor to extract meta information from the page based on the theme analyzed. The extracted meta information is stored in the memory device associated with the page.

The meta information generator may further comprise a pre-check unit to judge whether the page is a desired page based on the detected keywords. When the page is not a desired page, the page may not be stored in the memory device. Contrarily, the page may be stored in the memory device when the page is judged to be the desired one.

The middle processor may comprise a cache search unit. The cache search unit may judge whether the desired page already exists in the local memory device by matching the keywords with the meta information stored in the memory device. The cache search unit may instruct to read the page from the memory device when the page is judged to exist in the memory and may instruct to retry search for the page when it is not judged to exist in the memory. A page found by the retry search may be inputted to the meta information generator and the meta information generated may be associated with the page and is stored in the memory.

The middle processor may further comprise a search pre-processor to support the search conducted by the back processor by manipulating the keyword reflecting the intention of the user in a predetermined manner. The search pre-processor may comprise a condition adding unit to add a keyword which is made objective based on the intention of the user assumed from the keyword reflecting the intention of the user and search condition setting unit to set a search condition or formula including, for example, a logical OR in accordance with the original keyword and the added keyword. The added condition may be reflected in the guide given from the first agent.

The middle processor may further comprise a pre-search controller to predefine information the user may inquire, based on the personal information of the user. In this configuration, the middle processor may instruct the back processor to search, while the apparatus is not used by the user, for the assumed or anticipated information without an expressed instruction from the user. Pages thus acquired may be stored in the memory device together with the meta information so that the response to the user's future request is improved.

In one aspect of the present invention, the middle processor is implemented in a home server and the front processor is implemented in a device controlled by the home server. The front processor may present the operational information of the device, for example, control or status information of the device to the user and the middle processor may manipulate or improve the operational information and send it to the front processor.

In another aspect of the present invention, the back processor may be implemented in a server on a network for example in a web server. And the front processor may be implemented in a device, for example, a PC, a mobile terminal such as a mobile phone, which can access to the server. The front processor may accept a request for indicating information from the user and the back processor may acquire the requested information from an arbitrary information source on the network and send it to the front processor.

According to still another aspect of the present invention, a user support apparatus is provided. The apparatus comprises an agent controller which provides an agent to support a user, a request analyzer which analyzes a request input from the user, and a response controller which presents to the agent controller necessary information for the requested service when the service has been judged processible and otherwise records the requested service as an unattained service. The apparatus may further comprise a communication unit which electronically reports the recorded unattained service to the administrator of the apparatus.

The “request” may have a specific purpose such as “Teach me how to operate a PC” or may be a chat just like “Hello” to have a dialog with an agent. In this sense, “necessary information” may relate to the operation of a PC or to utterance data corresponding to each scene. “Utterance” in this specification refers not only to actually uttered words but also inputted text-based requests/responses to/from the agents and the like.

There are at least two cases where the service is judged not processible. In the first case, the request could not be analyzed or interpreted, whereas in the second case, information to respond to the request could not be found even though the request itself was properly interpreted. There are at least two cases where the information could not be found. In the first case, the information could not be found inside the apparatus, whereas in the second case, the information could not be found even after the search was conducted outside the apparatus. Contrarily the service is judged processible when the request is understood or interpreted and necessary information to cope with the request exists. A series of processes to handle the request is performed in an electronic manner and the term “understand” or “interpreted” is not necessarily used in the sense that a human can understand the request.

There are at least two meanings of “recording the requested service as an unattained service”. In the first meaning, the unattained service is recorded with an identifier while storing all the request in a log file. In the second meaning, only the unattained service is recorded when it is detected.

According to still another aspect of the present invention, a user support apparatus is provided. The apparatus comprises an agent controller which provides an agent to support a user, a conversation or dialog data storage which stores conversation to be held between the user and the agent, an request analyzer which analyzes a request input from the user, a response controller which determines a response to the request based on result of the analysis, and a log storage which stores the log of conversation actually held between the user and the agent. The response controller presents to the agent controller necessary information, read from the conversation data storage, for the requested service when the service has been judged processible and otherwise records in the log storage the requested service as an unattained service.

The “response” can be made regardless of whether the service is judged processible or not. An agent can “apologize” the user when the service is judged not processible. In this case, a front end process works to apologize the user and a back end process works to record the unattained service so that the system improvement on conversation data, an algorithm for analyzing the request and the sophistication of information search necessary for the service become possible.

According still another aspect of the present invention, a user support apparatus is provided. The apparatus comprises a first processor which conducts an agent level control and a second processor which conducts a character level control. The first processor comprises a total system manager which provides a field for a plurality of agents to interact and manages the agents, and a plurality of agent controllers each of which, through a character, acquires and interprets a user request so as to realize substantial functions of a respective agent. The second processor comprises a character manager which provides basic functions to visually represent interaction between the plurality of agents at the character level, and a plurality of character controllers, each of which corresponds to one of the agent controllers and provides a series of character actions to the corresponding agent controller for use therein. Interface between a “horizontal” function between the plurality of agents which is provided by the total manager and the character manager, and a “vertical” or an individual function provided by agent controller and the character controller, is predetermined for the plurality of agent controllers and the plurality of character controllers.

In this apparatus, the total support manager and the character manager have a function which works on a plurality of agents simultaneously. These managers therefore have a horizontal function to explicitly or implicitly work on a plurality of characters. On the other hand, the gent controller and the character controller have a vertical function which works on a specific agent. The interface between the horizontal and the vertical functions is standardized, which makes it possible to add a vertical function or an agent-dependent function later according to the interface. The interface allows to design new agent-dependent functions so that agent system is easily improved.

Characters can interact, for example, appear on the same screen and talk with each other as the interface absorbs the difference of the input/output formats of the characters. Conventionally, agents developed in different companies usually cannot communicate with each other. The present apparatus, however, realizes the communication by implementing agents obeying the interface. Based on this feature, a new type agent system is provided.

According to still another aspect of the present invention, a client-server system using a character to support a user is provided. In this system, the client comprises a first processor which conducts an agent level control and a second processor which conducts a character level control. The first processor comprises a total system manager which manages a plurality of agents to achieve interaction therebetween, and a plurality of agent controllers each of which, through a character, acquires and interprets a user request so as to realize substantial functions of a respective agent. The second processor comprises a character manager which represents the interaction between the plurality of agents at the character level, and a plurality of character controllers, each of which corresponds to one of the agent controllers and provides a series of character actions to the corresponding agent controller for use therein. In this system, the server, collaborating with the client, interprets the user request and presents to the client information necessary to respond the request.

The server may further comprise a control window manager which provides functions of the total manager and the character manager to the client. The server here may be any element, component, module, unit, device and the like which can provide a service to the client. The server may comprise a plurality of expert or specialized servers, each of which, for service in specific area, provides functions of the agent controller and the character controller to the client.

According still another aspect of the present invention, a user support method using a character is provided. The method conducts agent level control and character level control. The agent level control provides a total management process to manage a plurality of agents to achieve interaction therebetween and a plurality of agent control processes, each of which responds to a user request via a respective character. The character level control provides a character control process to represent the interaction between the agents at the character level and a plurality of character control processes, each of which corresponds to one of the agent control processes and provides a series of character actions to the corresponding agent control process. The interface between a horizontal function among the plurality of agents and a function individual to each agent is predetermined for the plurality of characters.

According to still another aspect of the present invention, a user support apparatus is provided. The apparatus comprises a user utterance identification block which comprises an electronic user utterance list holding assumed or anticipated utterances and identifies a user utterance when it is inputted, a plurality of response blocks, each of which makes one of agents being designed to have a respective specific area, respond to the inputted utterance when the utterance is included in the specific area assigned to the agent, and a registration unit which stores in a storage region provided for each specific area a network address of an web site according to a request of the user.

The “action” of an agent may be an imitated utterance, an image, a behavior and any other activities to be performed to support the user. In this sense, the action may relate to any process element or process flow. The e “storage region” relates to a conceptually single physical entity to classify the network addresses of web sites as bookmark information. The region, however, is not necessarily a single physically continuous area. The storage region works as a folder to classify files. A single folder may have subfolders in it so that the bookmark information may be layered.

The response block may comprise a search unit which searches a web site having information desired by the user therein. The registration unit stores the network address of the searched web site to a storage region assigned to the response block having the search unit which conducted the search.

The apparatus may further comprise a display unit which presents registered web sites classified to the storage regions.

According to still another aspect of the present invention, a user support system is provided. In this system, a plurality of user support apparatuses are connected to the network as independent nodes. Each apparatus has its own specific area. Each apparatus stores a respective response block while having the utterance identification block commonly with other apparatuses. The identification block is stored in one of the apparatuses. In this configuration, the apparatus containing the identification block in it may act as an entrance or portal server which can specify all the user utterances processible in the system. Based on the specified utterance, a suitable apparatus may be selected. The system efficiency can be improved as the system load is distributed by assigning the identification of the user utterance and the response from an agent to a plurality of nodes.

In this system, the user utterance collection may be provided by a library providing unit to any developers who wish to use the collection. The library providing unit may transmit the collection in an off-line or on-line manner. Off-line distribution may be realized with a normal mail. For on-line distribution, a server managing the user utterance collection therein may be provided. The use right of the library site is then licensed. In the user utterance collection, a general utterance library recording general utterances of users in a library described in natural languages may be licensed. According to this license scheme, a third party can develop its own user utterance collection and an agent action collection independently to realize its own user support apparatus, which eventually improves the functionality of the entire user support system.

According to still another aspect of the present invention, a user support apparatus is provided. The apparatus comprises a user utterance identification block which comprises an electronic user utterance list holding assumed or anticipated utterance and identifies a user utterance when it is inputted, and a response block which has an electronic agent action library to respond to the utterance and which makes an agent respond to the utterance, a search item holder which acquires and holds in advance items of information the user wishes to search, and a search unit which conducts search for the items. The utterance identification block further comprises an additional utterance list containing utterances for which the search unit is planed or programmed to start the search. The search unit starts the search when the user utterance is detected contained in the additional utterance list.

The content of the additional utterance collection may be included in the user utterance collection so that the user utterance collection may have the content of both of additional utterances and user utterances in this apparatus. In this configuration, a user utterance can be searched in the user utterance collection and the additional utterance collection simultaneously.

The search unit may start the search spontaneously without an instruction from the user. In this configuration, a quick response can be realized when the user requests a certain information as the search for information has been conducted beforehand. The searched information may be presented to the user without a user request. The search may be performed periodically or in hours when the network is not busy.

In this apparatus, each field of information may be associated with a character. The apparatus may further comprise a character display unit which presents to the user result of the search in the form of an utterance of a character which is associated with a field to which the search result is classified. In this configuration, the character appears to search for the information spontaneously so that a friendlier environment can be provided.

In this apparatus, the search item holder may further comprise a bookmark holder which stores the network address of a web site. The search unit acquires update information of the web site. The character display unit presents the user the update information in the form of an utterance of a character when a web site which is classified to a field with which the character is associated.

The present invention has been summarized according to several aspects thereof. These aspects are, however, only examples and arbitrary combinations of the above aspects or the elements therein are also effective.

### BRIEF DESCRIPTION OF THE DRAWINGS

FIG. 1 is a block diagram of the user support apparatus according to Embodiment 1.

FIG. 2 is another block diagram of the user support apparatus according to Embodiment 1.

FIG. 3 is still another diagram of the user support apparatus according to Embodiment 1.

FIG. 4 is still another diagram of the user support apparatus according to Embodiment 1.

FIG. 5 illustrates the configuration of the apparatus shown in FIG. 1.

FIG. 6 shows the internal structure of the agent storage in the front processor.

FIG. 7 shows the internal structure of the agent manager in the agent storage.

FIG. 8 is an information table generated as a subset of the personal information database to be referred to when a recipe is presented to the user.

FIG. 9 is a block diagram of the meta information generator in the middle processor.

FIG. 10 illustrates a meta information file generated in the middle processor.

FIG. 11 shows a collection of the meta information file and page data.

FIG. 12 shows the meta information file and page data associated with each other using link information.

FIG. 13 illustrates the structure of a search pre-processor in the middle processor.

FIG. 14 is a reference table provided in the search pre-processor of the middle processor.

FIG. 15 is a flowchart showing the process to read a target page from the cache memory or to store the page in the cache memory.

FIG. 16 is a flowchart to acquire beforehand a page which the user may need.

FIG. 17 illustrates a screen which first appears when the user uses an agent.

FIG. 18 illustrates a screen on which a recipe agent is called by a user-dedicated agent.

FIG. 19 shows the result of the initial search by the recipe agent.

FIG. 20 shows the result of the secondary search by the recipe agent.

FIG. 21 is a flowchart for a service to be performed when the user issues a request.

FIG. 22 illustrates the configuration of an apparatus according to Embodiment 2.

FIG. 23 is a flowchart showing the process to initiate an agent in Embodiment 2.

FIG. 24 illustrates the interaction between the user and the agent in Embodiment 2.

FIG. 25 illustrates the interaction between the user and the agent in Embodiment 2.

FIG. 26 illustrates the interaction between the user and the agent in Embodiment 2.

FIG. 27 illustrates the interaction between the user and the agent in Embodiment 2.

FIG. 28 illustrates the interaction between the user and the agent in Embodiment 2.

FIG. 29 illustrates the interaction between the user and the agent in Embodiment 2.

FIG. 30 is the internal block diagram of the log storage.

FIG. 31 shows an unattained request list.

FIG. 32 show s the configuration of a client-server system according to Embodiment 3.

FIG. 33 shows the structure of a control window management site according to Embodiment 3.

FIG. 34 shows the structure of a chat server according to Embodiment 3.

FIG. 35 shows the structure of an index file contained in the chat server.

FIG. 36 shows the structure of an assumed utterance collection contained in the chat server.

FIG. 37 shows the structure of an access information file contained in the chat server.

FIG. 38 shows the structure of an action file contained in the chat server.

FIG. 39 shows the structure of a user terminal which is a client machine.

FIG. 40 illustrates a chat agent which appears when the user terminal is initiated.

FIG. 41 illustrates a recipe agent which appears together with the chat agent when the user asks about recipe.

FIG. 42 illustrates the dialog held between the chat agent and the recipe agent.

FIG. 43 illustrates a scene where the recipe agent presents the search result to the user.

FIG. 44 shows a scene where a third agent or a travel agent appears to respond to the user.

FIG. 45 shows the entire structure of a network system including a user support system according to Embodiment 4.

FIG. 46 shows the structure of an originating server included in the user support system.

FIG. 47 shows the structure of the user utterance collection contained in the originating server.

FIG. 48 shows the structure of an access information file contained in the originating server.

FIG. 49 shows the structure of a bookmark file contained in the originating server.

FIG. 50 shows the structure of a gourmet server contained in the user support system.

FIG. 51 shows the structure of a user terminal used in the user support system.

FIG. 52 illustrates a local agent which appears when the user terminal is initiated.

FIG. 53 illustrates a chat agent which appears when the user speaks.

FIG. 54 illustrates a gourmet agent which appears when the user asks a question regarding a Peking ravioli restaurant.

FIG. 55 illustrates a screen where the gourmet agent presents the search result to the user.

FIG. 56 illustrates a screen where a registered bookmark information is presented to the user.

FIG. 57 shows the internal structure of the originating server.

FIG. 58 shows the internal structure of an additional index file.

FIG. 59 shows the internal structure of an additional user utterance collection.

FIG. 60 shows the internal structure of the gourmet server.

FIG. 61 shows the internal structure of the favorite data.

FIG. 62 shows the structure of a page stored in the agent action library.

FIG. 63 shows the screen displayed based on the page.

FIG. 64 shows the screen in which the favorite register accepts the registration of a bookmark from the user.

FIG. 65 shows the screen in which a favorite character registered by the user is displayed.

FIG. 66 shows the screen in which Gourmet Agent presents the search result.

### DETAILED DESCRIPTION OF THE INVENTION

The invention will now be described based on the preferred embodiments, which do not intend to limit the scope of the present invention, but exemplify the invention. All of the features and the combinations thereof described in the embodiments are not necessarily essential to the invention.

Embodiment 1

A user support apparatus according to embodiment 1 supports a user employing two types of agents. The first agent or a user-dedicated agent provides services to the user in one-to-one relation with the user to be friendly to the user. The second agent or an expert agent has its own specific area such as information search and so on responsive to the user's request.

The first agent generally has more opportunities to contact the user and accumulates the personal information of the user such as purchase record, food, hobby, health condition and so on. The first agent presents a guide to the expert agent for the user when the expert agent acts for the user.

When the user, for example, requests the movie expert agent to recommend new arrivals, the first agent, knowing the user's preference as “horror” and “love comedy”, may utter on the screen, “Let us know very horrible ones” or “Try to find lovely and funny ones”. Then the second agent may respond, “Trust me. Wait for a moment.”

From the conversation between the agents, the user can understand the search process is conducted properly. The more precisely the first agent can convey the feeling of the user, the more the user feels convenient with the first agent. The user may feel intimacy with the first agent as a virtual pet. The more intimately the user feels with the first agent, the more easily the first agent can collect the personal information of the user as a general tendency. The image or any other appearance of the first agent may be selected by the user or may be designed by the user.

The purpose of the present embodiment is almost achieved if the conversation between the agents is funny. In conventional search methods, for example, “Now searching. Please wait for a moment” or the like may be displayed but the user is not saved. According to the present embodiment, the agents can give a relaxation to the user while the user is waiting for the search result, by playing a comic chat.

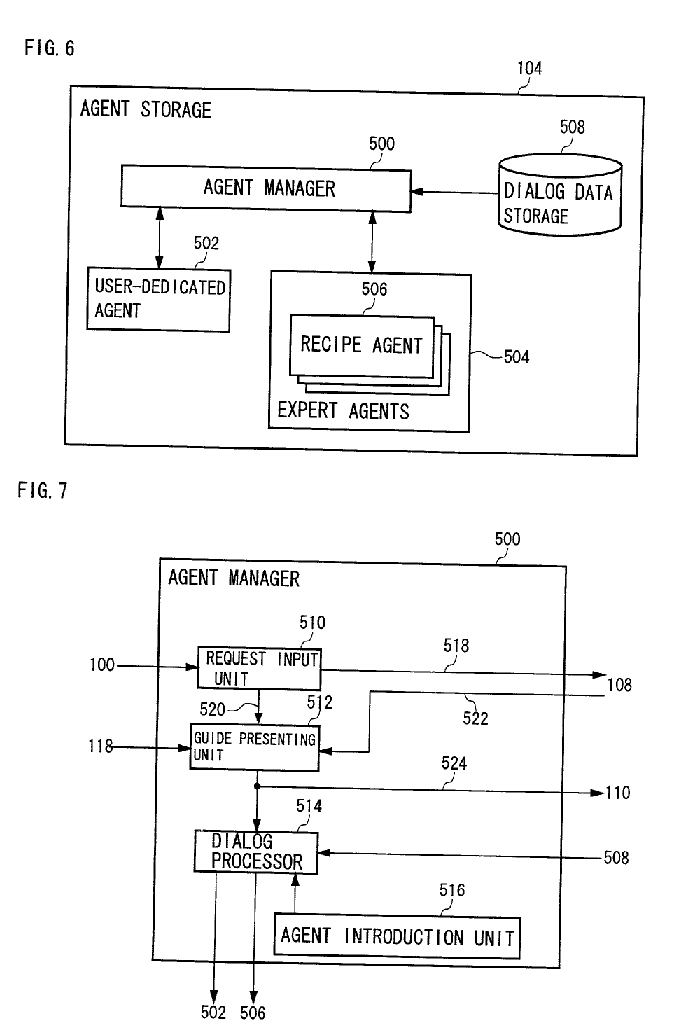

The agents are mainly described in FIGS. 6 to 8 and FIG. 17 and later.

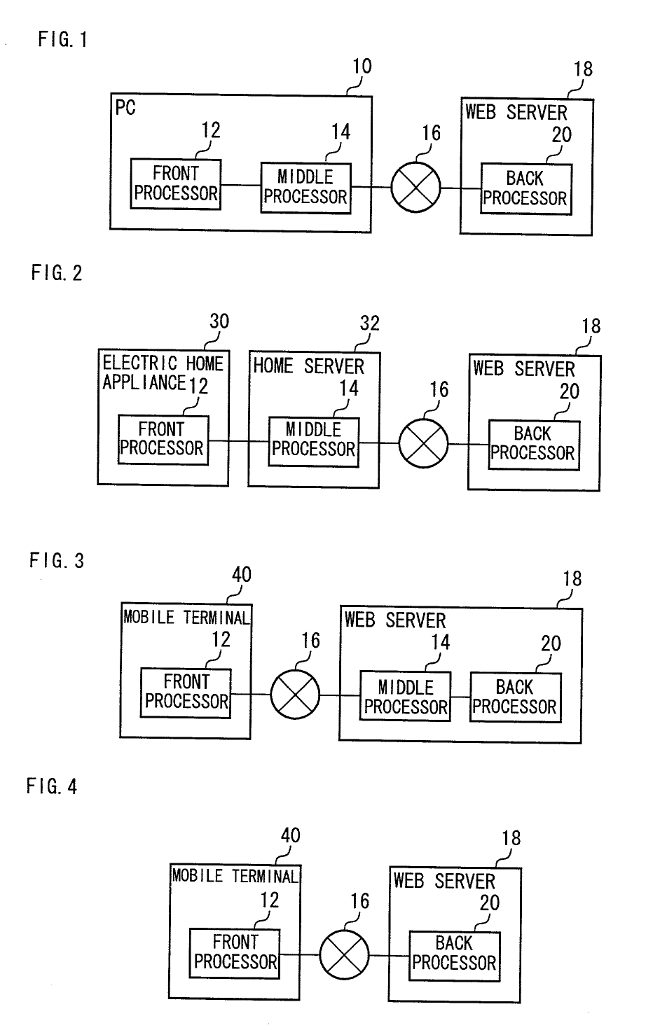

FIGS. 1 to 4 illustrate various types of user support apparatuses according to the present embodiment. In any case, the apparatus comprises an arbitrary combination of a front processor 12, a middle processor 14 and a back processor 20, which are the three major processing units. The front processor 12 interacts with the user. The middle processor 14 supports the front processor 12 behind it and acquires and stores necessary information in the format the user needs. The back processor 20 collects necessary information from the Internet and provides it to the middle processor 14. The back processor 20 further, as a server, provides expert agents described later to more efficiently support the front processor 12.

In FIG. 1, the user support apparatus comprises the front processor 12 and the middle processor 14 implemented in a PC 10. The apparatus may include the back processor 20. It should be noted that the degree of freedom to combine the processors is high. The middle processor 14 communicates with the back processor 20 implemented in a web server 18 via the Internet 16.

In FIG. 2, the front processor 12 is implemented in a home electric appliance 30 and the middle processor 14 is implemented in a home server 32. The middle processor 14 communicates with the back processor 20 implemented in the web server 18 via the Internet 16. The home appliance 30 may be an audio-visual appliance such as a digital television set, a VCR and a digital camera. The home appliance 30 may be a traditional appliance such as a refrigerator and a washer, or may be any other appliances including a home security appliance having sensors. In any case, the home appliance 30 is managed by the home server 32. The front processor 12, for example, manages information displayed on a LCD panel provided on a refrigerator, obtains user's instruction with regard to the icebox and informs the user of the condition of the icebox. The middle processor 14 on the other hand may display “today's recipe” and other information which is beyond the normal operational information of the refrigerator.

In FIG. 3, the front processor 12 is implemented in a mobile terminal 40 such as a cellular phone and the middle processor 14 and the back processor 20 are both implemented in the web server 18 where the mobile terminal 40 and the web server 18 communicate via the Internet 16. In this configuration, the middle processor 14 is also implemented in the web server 18 and the mobile terminal 40 is comparably easily realized in a small body of the terminal.

In FIG. 4 the configuration is almost the same as FIG. , but only the back processor 20 is implemented in the web server 18. The middle processor 14 is skipped to provide a simplified service.

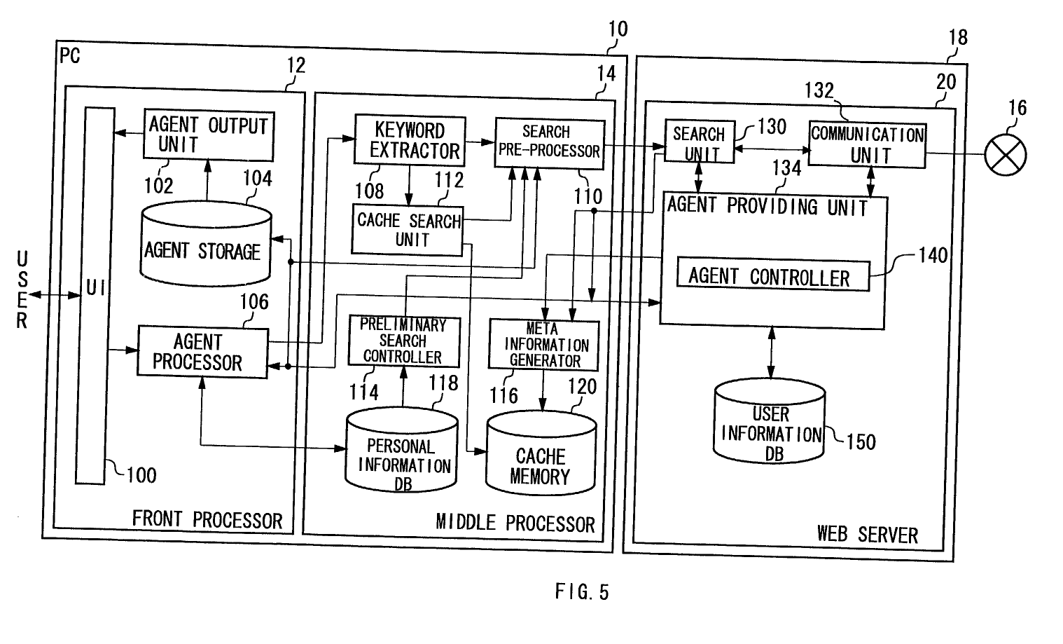

FIG. 5 is a block diagram of the user support apparatus according to the configuration shown in FIG. 1. The PC 10 may be a normal computer and comprises a PCU, memory and program modules to support users loaded on the memory. The blocks here are drawn in terms of functions characteristic to the present embodiment and the skilled in the art can understand the blocks can be realized with hardware only, software only or any other combinations of the two.

The front processor 12 and the middle processor 14 are implemented in the PC 10. The back processor 20 is implemented in the web server 18. The PC 10 and the web server 18 communicate via the network. In FIG. 5, the middle processor 14 and the back processor 20 are drawn closely, but in reality the Internet 16 exists between the two.

The front processor 12 has a user interface or UI 100 to input the user's instructions and to conduct any other user-related matters. The UI 100 may comprise an input device such as a keyboard and a mouse, a display device to display information to the user, and GUI and other programs.

An agent storage 104 has object data describing agents to support users. The object data may be hereinafter simply referred to as “the data” or “the agent data”. An agent output unit 102 outputs the agents to the user including the first and the second agents.

The first agent is user-dedicated and is provided by an agent providing unit 134 for each user in order to obtain the personal information of the user. The personal information is used for customizing services conducted by the second agent. The user-dedicated agent has a function to chat with the user to acquire the personal information. The function is made active when the agent has been frequently used by the user. For example the agent is switched to a “friend” internally when the number of contacts between the user and the agent reaches a predetermined value.

The second type agents are experts for each specific area such as cooking, movie, travel, PC, new products and shopping. The second agents conduct information search and provide desired information to the user.

From a different criterion, the agents are classified to “local agents” and “remote agents”. The local agents are originally held by the front processor 12 in a local environment and provide guidance information concerning the PC 10 to the user. The local agents may be realized with the functions of the OS of the PC 10, with the functions of application programs implemented in the PC 10, or with other functions. The local agents and the remote agents may be designed in such a manner that the user cannot distinguish them.

The remote agents are provided by the agent providing unit 134. The remote agents may stay in the agent storage 104 after downloaded to the agent storage 104 or may be deleted from the agent storage 104 after the session between the PC 10 and the web server 18 is finished. The user may select whether the remote agents should stay or should be deleted. Here, the remote agents are mainly described although the user-dedicated agents and the expert agents may be local.

An agent processor 106 conducts necessary processes when the user issues an instruction to any one of the agents via the UI 100. The agent storage 104 and the agent output unit 102 work as a mechanism to output the agent to be shown to the user, whereas the agent processor 106 works as a mechanism to input user instructions to the agent and to send the instructions to the middle processor 14.

When the user asks an expert agent to provide information, the agent inquires the necessary information to the middle processor 14 reflecting a guide given from the user-dedicated agent. The middle processor 14 reads necessary information from a cache memory 120 when it is stored in the memory 120 and sends it to the expert agent. When the necessary information is not stored in the memory 120, the middle processor 14 instructs the back processor 20 to acquire the necessary information from an arbitrary site on the Internet 16 and to send it to the middle processor 14. Information thus obtained via the Internet 16 is hereinafter referred to as a “page” after the file format of HTML. The middle processor 14 modifies the page sent from the back processor 20 to store in the cache memory 120 for future use, while providing it to the user.

A search unit 130 of the back processor 20 searches for the page requested from the middle processor 14 via a communication unit 132. The search unit 130 may be a meta search engine which can conduct search simultaneously using multiple search engines existing outside the apparatus. In that case, the search process is generally more efficient and reasonable.

An agent controller 140 of the agent providing unit 134 generates and manages remote agents and provides them as object data to the front processor 12. The object data includes image data, chat data and other attribute data to provide characters to the remote agents. When the user gives a task to an agent in the front processor 12, the task is obtained at the agent controller 140 and necessary action such as search is fulfilled.

A user information DB 150 stores the personal information of the user obtained through questionnaires, chat with agents and other routes in order to provide information to fit to the user preference and to more efficiently customize the functions of the user-dedicated agents.

FIG. 6 illustrates the object data developed inside the agent storage 104. An agent manager 500 manages expert agents 504 including the user-dedicated agent 502 and a recipe agent 506. The user-dedicated agent 502 is a “chat agent” whose main function is to chat with the user. Now the recipe agent 506 is described as an expert agent. The agent manager 500 controls the actions and conversation of the agents by selecting necessary chat data and the like from a dialog data storage 508 and by sending the data to the agent.

FIG. 7 illustrates the internal structure of the agent manager 500. A request input unit 510 acquires a user request via the UI 100. The acquired request 518 is sent to a keyword extractor 108, which extracts keywords in a manner described later.

The extracted keyword 522 is sent back to a guide presenting unit 512 of the agent manager 500. The unit 512 obtains user information from a personal information DB 118 and generates a guide which should be given from the user-dedicated agent 502 to the recipe agent 506.

The generated guide 524 is sent to a search pre-processor 110 and a dialog processor 514. The search pre-processor 110 sets a search condition or formula taking the guide 524 into consideration. The dialog processor 514 extracts from a dialog data storage 508 based on the guide 524, conversation data which the user-dedicated agent 502 should utter and another conversation data which the recipe agent 506 should utter to respond to the user-dedicated agent 502, and sends the data to the user-dedicated agent 502 and recipe agent 506, respectively. The agents utter the conversation data.

The user may enhance, modify or deny the guide 524 and input another instruction when the user-dedicated agent 502 shows the guide 524 to the expert agent in manner recognizable from the user, for example, by displaying on the screen or by voice. The instruction from the user is also obtained by the request input unit 510 and is transmitted to the guide presenting unit 512 indicating that the instruction, which is hereinafter referred to as a “priority instruction 520”, has higher priority than the guide 524. The guide presenting unit 512 generates another guide 524 in accordance with the priority instruction 520 and transmits it to the search pre-processor 110 and the dialog processor 514. In this manner, the service by the agents is modified.

An agent introduction unit 516 functions to make the user-dedicated agent 502 introduce expert agents such as the recipe agent 506 to the user. This function is initiated when the user-dedicated agent 502 calls an expert agent suitable for the request of the user. The dialog processor 514 retrieves, from the dialog data storage 508, conversation data necessary to introduce the expert agent. The retrieved data is transmitted to the user-dedicated agent 502. The user-dedicated agent 502 introduces the functions and roles of each expert agent to the user.

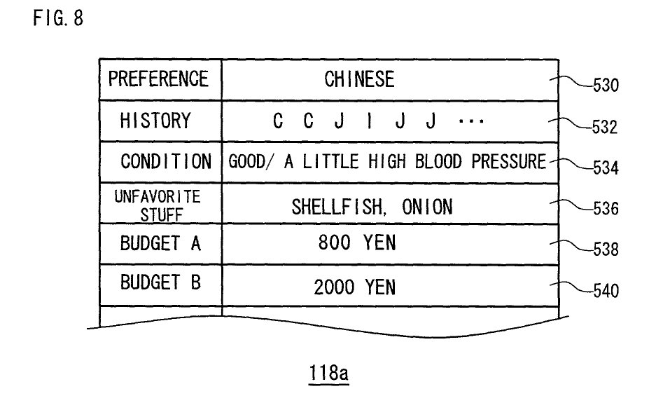

FIG. 8 illustrates a subset 118a which is extracted from a personal information DB 118 to recommend a recipe to the user under the collaboration of the user-dedicated agent 502 and the recipe agent 506. The subset 118a comprises a preference column 530, a column of recent meals 532, a health condition column 534, a column indicating user's unfavorite foodstuff 536, a budget ‘A’ column indicating the acceptable budget for ordinary meals 538 and a budget ‘B’ column indicating the acceptable budget for special dinner 540. According to FIG. 8, the user likes Chinese food. The user recently had Chinese (C), Chinese, Japanese (J), Chinese, Italian (I), Japanese, Japanese . . . as his/her meal. The health condition of the user is generally good but the blood pressure is a little high. The user dislikes shellfish and onion. The budget A is 800 yen and the budget B is 2000 yen.

In this circumstance, when the user inputs a request “Recommend a recipe”, the request is acquired by the request input unit 510 although the user believes that the request is accepted by the user-dedicated agent 502. The keyword extractor 108 extracts keywords such as “recipe”, “recommend”, which are returned to the guide presenting unit 512. The guide presenting unit 512 generates a guide 524 such as “not salty” referring to the health condition described in the subset 118a. The guide 524 is transmitted to the search pre-processor 110 and is ANDed to the keywords described later to limit the number of candidates to recommend.

The guide 524 is also transmitted to the dialog processor 514. The user-dedicated agent 502, under the control of the dialog processor 514, talks to the recipe agent 506 “Don't choose salty ones”. By this time, the search pre-processor 110, knowing the guide 524, has prepared the actual search, which is executed by the search unit 130. The user-dedicated agent 502 shows the process to the user by the conversation with the recipe agent 506. The response of the recipe agent 506 may be simply as “Wait for a moment”. The response may be prepared such that it is independent from the guide given by the user-dedicated agent 502.

The guide presenting unit 512 may detect, referring to the history column 532, that the user has recently had so many Chinese meals and may make the user-dedicated agent 502 utter “Don't recommend Chinese food”, “Recommend Japanese or Italian food”. In the same manner, the guide presenting unit 512 may make the user-dedicated agent 502 utter, referring to the unfavorite stuff column 536, “Avoid shellfish ” and “Below 800 yen” referring to the budget A column 538.

The guide 524 from the guide presenting unit 512 may be considered when the search pre-processor 110 generates the search condition. Otherwise the guide 524 may be introduced when the search result by the search unit 130 has too many hits or when the search result contains too many pieces of information the user do not desire. The guide presenting unit 512 therefore may issue the guide 524 at several different timings checking the search process or result.

The guide presenting unit 512 for example makes the user-dedicated agent 502 utter “You recommended the same recipe yesterday”, “Don't exceed the budget”, “Avoid onion” when the search result is revealed without giving the guide 524. In a background process, the guide presenting unit 512 may generate the guide 524 in the form of keywords such as “budget below 800 yen”, “NOT onion” to exclude “onion” in the search and sends the guide 524 to the search pre-processor 110. Receiving the guide 524, the search pre-processor 110 creates a new search condition and sends it to the search unit 130, which retries search to find recipe information more suitable for the user.

The guide presenting unit 512 may generate many guides 524 referring to the subset 118a to limit the candidates when the search result includes too many information items. The guide presenting unit 512 may ask the user “We found too many items. Do you have any specific preference?” to acquire more keywords when the search result includes too many items even after the injection of many guides 524.

The user, on the other hand, may input “I like Chinese food” when the user-dedicated agent 502 says “Don't recommend Chinese food” to the recipe agent 506. The utterance of the user is handled as a priority instruction 520 and is provided to the guide presenting unit 512, which initiates search over Chinese recipe.

The user-dedicated agent 502 may ask questions to the user when the request inputted from the user is unclear. The user-dedicated agent 502 may first ask “Which food do you prefer 1.Chinese 2.Japanese 3.Italian . . . ?”. The user-dedicated agent 502 may then ask “Which foodstuff do you like 1.pork 2. meat 3.chiken 4.fish 5.vegetable . . . ?” when the user shows “1.Chinese” to the first question.

The search by the recipe agent 506, which is in reality conducted referring to the preference column 530, may take time. The user-dedicated agent 502 may have conversation with the recipe agent 506 to give a relaxation to the user. The user-dedicated agent 502 may start conversation with the recipe agent 506 when the duration of the search exceeds a predetermined value. The duration may be measured by a timer which is provided in the user-dedicated agent 502 or in any other part of the apparatus. The user-dedicated agent 502 (simply referred to as “502” in the following conversation) may complain to the recipe agent 506 (simply referred to as “506”) for the user as follows.

(502) “Are you still searching! Are you really professional?

(506) “It's you who should help me if you have time to complain.”

(502) “You always say ‘Don't touch my job. I'm professional.’ Was it a lie?”

(506) “I don't tell a lie except to my wife. That's why we can live happily.”

(502) “It is persuasive.”

Many dialog templates can be prepared beforehand, as scenes where the agents should give a relaxation to the user are limited to a few cases.

In FIG. 5, the front processor 12 can provide agent services to the user with the help of the back processor 20. In that sense, the middle processor 14 is not indispensable for the collaboration of the front processor 12 and the back processor 20. The middle processor 14, however, plays an important role to more efficiently support the user by managing pages requested by the front processor 12. The middle processor 14 is now described.

An agent processor 106 acquires a request inputted via the recipe agent 506. The request generally takes a form of a natural sentence as “Let me know a good recipe on meat”. The user naturally may input the request with independent keywords from the beginning. It is assumed here that the user inputs a request with a natural sentence.

The keyword extractor 108, receiving the request, decomposes it to minimum units or words and extracts keywords, such as “meat”, “food” and “recipe”, to reflect the intention of the user. The obtained keywords are hereinafter referred to as “initial keywords” to be distinguished from keywords given by the search pre-processor 110 described later.

The initial keywords are transmitted to the search pre-processor 110. The search pre-processor 110 deletes unnecessary keywords and generates more objective and suitable keywords, which are hereinafter referred to as “objective keywords”, as the initial keywords have not necessarily been selected to be most suitable for the search. Keywords not having been deleted, which hereinafter referred to as “selected initial keywords”, are then logically ANDed or multiplied with the objective keywords. The result by the AND operation is then logically ANDed with the guide 524 endowed by the guide presenting unit 512 of the agent manager 500, and the final result is transmitted to the search unit 130 of the back processor 20 as a search condition in the form of a formula.

The search unit 130 conducts search over web sites and pages using the search condition via the communication unit 132 and the hit information items, which hereinafter referred to as “target pages” are obtained and sent to the agent controller 140 or directly to the agent processor 106.

The target pages are also sent to a meta information generator 116, which generates necessary meta information and stores the information with the target pages in the cache memory 120. The information stored in the cache memory 120 then becomes ready for the user's future search. The cache memory 120 may be a disk type, semiconductor type and any other types of memory.

The initial keywords extracted by the keyword extractor 108 are also sent to a cache search unit 112. The cache search unit 112 searches in the cache memory 120 using the keywords such as “meat” and reads a desired page, which is already stored therein while instructing the search pre-processor 110 or the search unit 130 to stop the global search to the Internet. The page thus obtained is displayed to the user via the recipe agent 506. When the desired page, on the other hand, does not exist in the cache memory 120, the global search through the search pre-processor 110 and/or the search unit 130 is executed.

The personal information DB 118 stores various information regarding the user including eternal information such as the preference of meals and hobbies, and temporal information such as the recent meals the user had. The personal information is generally acquired through the agent processor 106 while the user is interacting with the user-dedicated agent 502. In another embodiment, the apparatus may comprise a schedule management function as a PIM or personal information manager, a health management function to calculate the calorie of the meals, and an accounting function to record the prices of goods the user purchased. The personal information may be obtained through such functions.

A preliminary search controller 114 specifies information in which the user may be interested based on the personal information stored in the personal information DB 118 and sends keywords concerning the specified information to the search pre-processor 110. The search pre-processor 110, triggered by the keywords sent from the preliminary search controller 114, generates the objective keywords and the search condition, by which the search unit 130 starts the search. The search process initiated by the preliminary search controller 114 may be preferably handled in a background manner, for example, during nighttime when the user does not use the apparatus or during the daytime when the user does not input any instructions for a predetermined period. The process may be conducted when a mail program, not shown, establishes the connection with the Internet to download new e-mails. In any case, as long as the search process is handled in a background manner, the meta information generator 116 can have sufficient time for the processing.

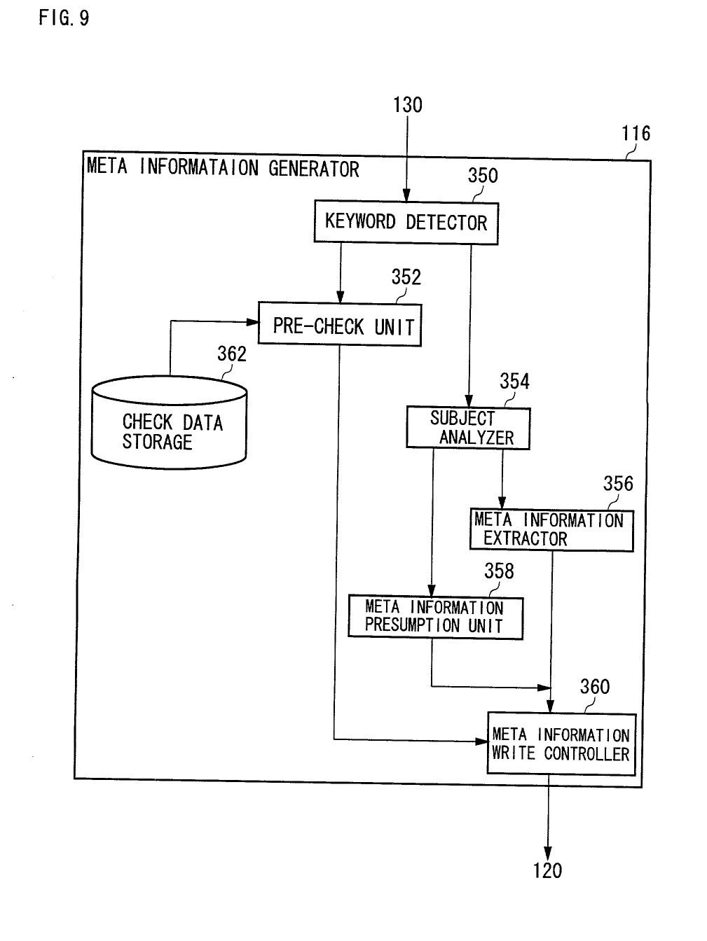

FIG. 9 shows the internal structure of the meta information generator 116. The target page sent from the search unit 130 is inputted to a keyword detector 350. The detector 350 detects keywords from the target page analyzing the sentences and phrases contained in the target page. The detected keywords, which are hereinafter referred to as “keywords for checking”, are transmitted to a pre-check unit 352.

The pre-check unit 352 judges whether the target page is really a page the user desires, based on the data stored in a check data storage 362. The storage 362 stores frequent or important keywords for each segmented subject. Similar to a portal site, the subject may be first roughly classified into “news”, “computer”, “travel”, “gourmet”, “auction”, “money”, “sports”, “entertainment”, “music” and “job”. The “gourmet” may be subdivided to “restaurants”, “events”, “pro's recipe” “ethnic dish”, “cooking programs”, “nutrition” and “special information”. The check data storage 362 obtains keywords by, for example, checking the pages of the sites registered in the portal site according to each subdivided subject.

The pre-check unit 352 judges whether each of the checking keywords belongs to the above-mentioned subjects or subdivided subjects by matching the keywords for checking and keywords stored in the check data storage 362. The target page is judged to meet the user's purpose when many keywords for checking belong to the subject “gourmet” and the initial keywords “meat”, “dish” and “recipe” which reflect the user's intention belong to the same subject “gourmet”. Instead of the subject “gourmet”, the subdivided subject “pro's recipe” may be used. In that case, the target page may be judged to be appropriate when 20% of the keyword for checking belong to “pro's recipe”. The major function of the pre-check unit 352 is not to conduct a rigid check, but to delete pages which are apparently away from the user's intention. In this sense, the judgment may be relaxed. The process result is sent to a meta information write controller 360.

A subject analyzer 354, which is almost the same as the pre-check unit 352, acquires the keywords for checking from the keyword detector 350. The subject analyzer 354, however, does not concern about the initial keywords and specifies a subject or a subdivided subject to which most of the keywords for checking belong. When “pro's recipe” is for example specified, the subject analyzer 354 judges the theme of the target page is “dish”, especially “recipe”, which is conveyed to a meta information extractor 356 and a meta information presumption unit 358.

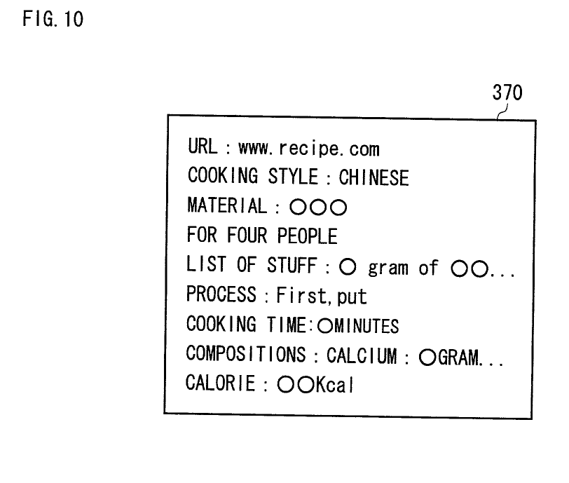

The meta information extractor 356 searches information concerning “recipe” in the target page and generates a file which is a collection of meta data, which is hereinafter referred to as “meta information file”. FIG. 10 illustrates an example of the meta information file 370. In this file, a template comprising items such as “classification” and “name of dish”, in which necessary information pieces detected in the target page are embedded.

The meta information presumption unit 358 presumes meta information for the items in the meta information file 370 for which suitable information has not been detected in the target page. For example, when “calorie” in FIG. 10 is left unfilled, the presumption unit 358 may calculate the calorie roughly referring to the items “material”, “list of stuff” and “component”. The equation to calculate the calorie may be recorded in the presumption unit 358 together with the template. Besides the template for cooking, a template for travel may be provided with the items “travel time”, “travel fees” and “the sights to see”. Meta information may be picked up from digital maps, train schedule, travel guide of the area and so on which have been investigated beforehand when the information in the template for traveling is not found in the target page. When the user is interested in traveling, the preliminary search controller 114 may obtain information to presume meta information using maps and other various information available on the Internet. The pages containing the above-mentioned map information and so on may be stored in the cache memory 120 beforehand for future use from the user.

The meta information file 370 generated by the meta information extractor 356 and reinforced by the meta information presumption unit 358 is sent to the meta information write controller 360. The controller 360, after the approval by the pre-check unit 352, stores the meta information file 370 and the target page together in the cache memory 120.

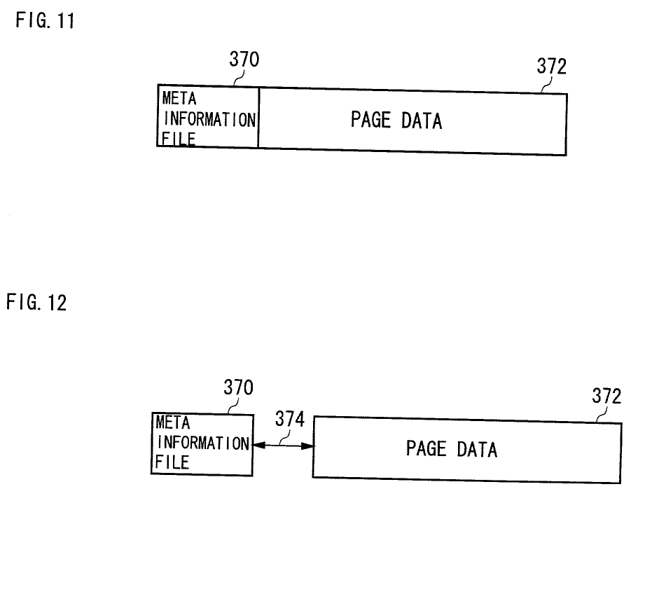

FIG. 11 illustrates the association of the meta information file 370 and a page data 372 of the target page. The content of the meta information file 370 is embedded in the header or any other portion of the page data 372. The meta information file 370 and the page data 372 may be combined in a text file written in XML (Extensible Markup Language) as follows.

<recipe mata information>

<URL>www.recipe.com</URL>

<classification>Chinese</classification>

</recipe meta information>.

FIG. 12 illustrates another combination of the meta information file 370 and the page data 372. The meta information file 370 and the page data 372 are generated independently and a link information 374 is recorded. In this configuration, the cache search unit 112 conducts search on the meta information file 370 and desired data is read from the cache memory 120 referring to the link information 374.

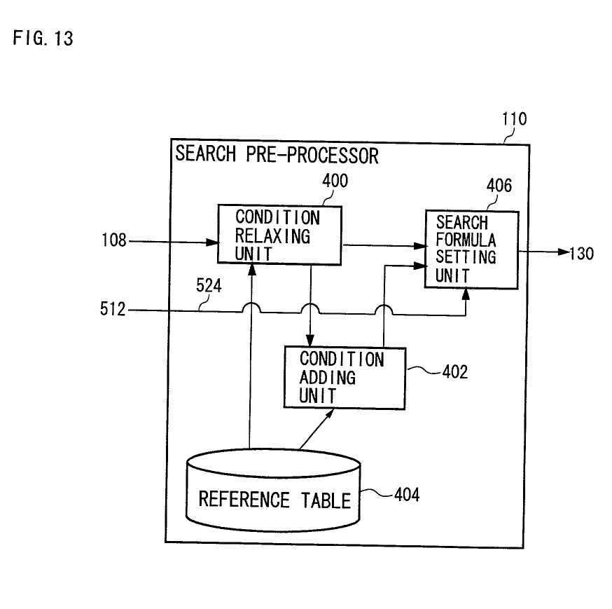

FIG. 13 illustrates the internal structure of the search pre-processor 110. The initial keywords extracted by the keyword extractor 108 are sent to a condition relaxing unit 400. The condition relaxing unit 400 determines which words to be deleted, referring to a reference table 404. The reference table 404 records keywords which are too strict or which reduce the number of hits too drastically. Such words can be identified based on the past search record. Such deleted keywords are hereinafter referred to as “invalid keywords”. The condition relaxing unit 400 sends to a condition adding unit 402 and a search formula setting unit 406 the remaining keywords or selected initial keywords. The invalid keywords are informed to the condition adding unit 402.

The condition adding unit 402 identifies the objective keywords referring to the reference table 404 using the selected initial keywords and/or the invalid keywords and sends the objective keywords to the search formula setting unit 406. The selected initial keywords are logically ANDed with the objective keywords and the result is then ANDed with the guide 524 sent from the guide presenting unit 512 in the search formula setting unit 406 to obtain the search condition which is sent to the search unit 130.

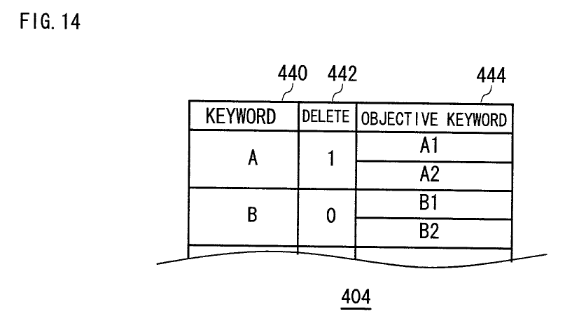

FIG. 14 illustrates the internal data of the reference table 404. The reference table 404 comprises a keyword column 440, a deletion column 442 and an objective keyword column 444. The keyword column 440 records the initial keywords. The deletion column 442 shows the invalid keywords with a flag bit being “1”. The selected keywords are shown with the flag being “0”. The objective keyword column 444 shows objective keywords corresponding to the initial keywords which are identified from the past search history or by an operator.

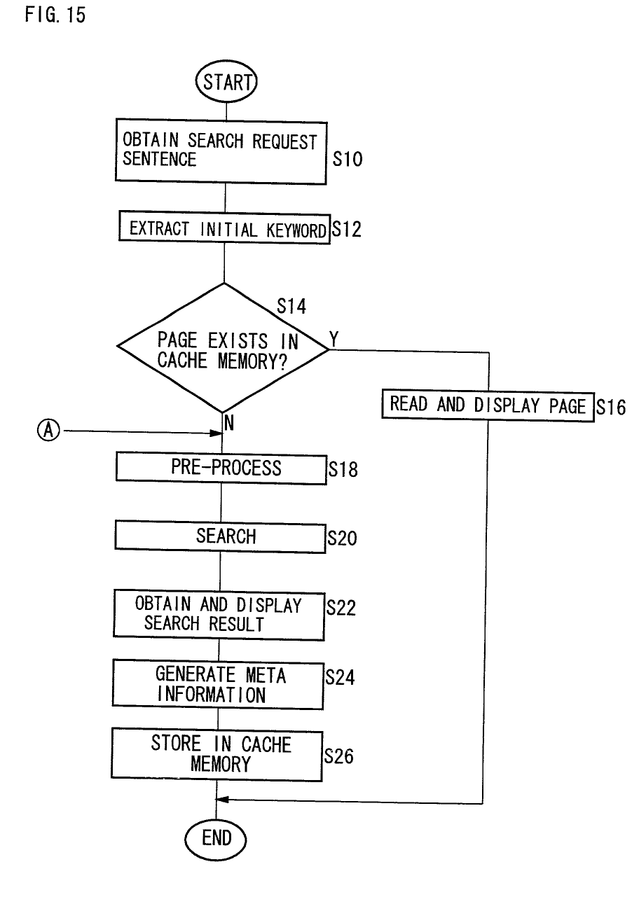

FIG. 15 shows the process flow of the middle processor 14. The user first inputs a search request “Let me know a recipe on meat” to the recipe agent 506. The request is acquired by the agent processor 106 (S10) and the initial keywords “meat”, “dish” and “recipe” are extracted (S12). The initial keywords extracted are sent to the cache search unit 112, which conducts search over the cache memory 120 (S14) and reads the desired page when it is cached (S14Y). The page is read and displayed (S16).

When the desired page is not cached (S14N), the search pre-processor 110 conducts the preprocess (S18) through identifying the invalid keywords, endowing the objective keywords and setting the search condition reflecting the guide 524 sent from the guide presenting unit 512. The search unit 130 searches the page on the Internet (S20).

The page found by the search or the target page is displayed as if it were found by the recipe agent 506 obeying the guide 524 from the user-dedicated agent 502 (S22). The target page is sent to the meta information generator 116, which conducts the pre-check, the analysis of the subject, the extraction and presumption of the meta information. The meta information is then generated as a file shown in FIG. 10 (S24). The meta information is associated with the target page in the manner shown in FIG. 11 or 12 and is stored in the cache memory 120 (S26).

According to the process flow, information necessary to the user is generally promptly provided based on a search request which is inputted by the user and which may be subjective to some degree while the search process is being shown to the user. The desired page can be appropriately searched when it is in the cache memory 120 as the meta information is added and cached. It is more probable, according to the present embodiment, that the page read from the cache memory 120 meets the user's intention. Caching efficiency is generally high as the meta information generator 116 pre-checks data to be cached.

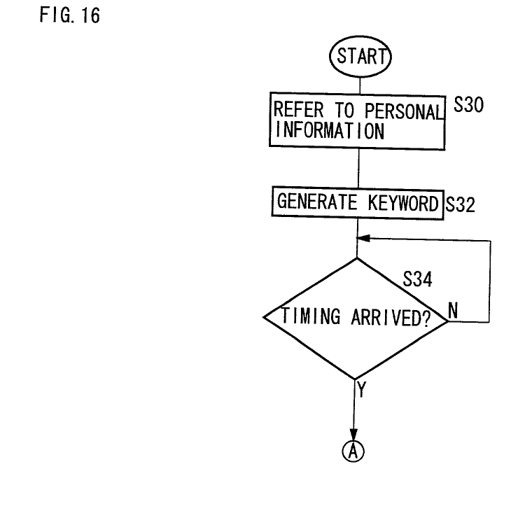

FIG. 16 illustrates the flow of the pre-search conducted by the preliminary search controller 114 as a background process. The user records his/her daily meals in the history column 532. The user likes Chinese food (S30). The preliminary search controller 114 expects an inquiry from the user concerning the Chinese recipe when it detects that the user has not had Chinese food for one week, and generates keywords such as “Chinese”, “dish” and “recipe” (S32).

The preliminary search controller 114 judges the timing for the background search has come when it becomes midnight or the like (S34Y) and sends the generated keywords to the search pre-processor 110. The process shifts to FIG. 15 via the route “A”. According to this embodiment, the apparatus can be a highly customized agent machine to quickly respond to the user.

The front processor 12, the middle processor 14 and the back processor 20 have been described. Now the service actually provided by the user-dedicated agent 502 and the recipe agent 506 is described.

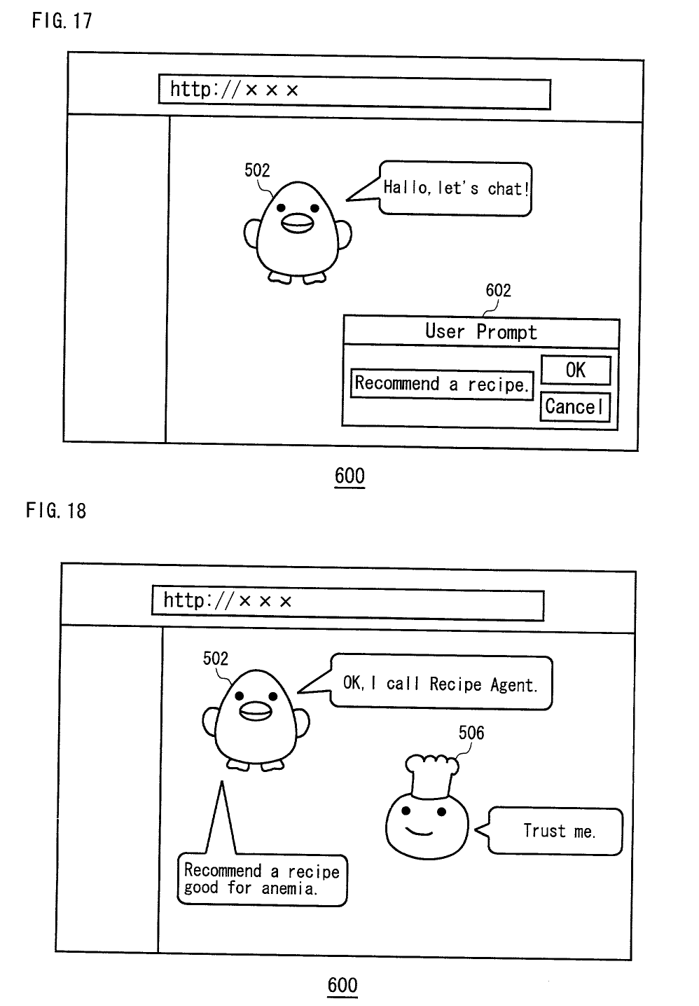

FIG. 17 illustrates the initial screen 600 on the PC 10 for the agent service. The user-dedicated agent 502 appears on the screen 600 and says, “Hello, let's chat!”. The user may input an instruction via voice. In FIG. 17, however, an input region 602 appears on the screen 600. The user inputs “Recommend a recipe” in the input region 602. The request is obtained by the request input unit 510 and is processed in the aforementioned manner.

A new scene is created by the agent introduction unit 516 where the user-dedicated agent 502 introduces the recipe agent 506 to the user. FIG. 18 shows the scene. The user-dedicated agent 502 says “OK, I call Recipe Agent”. The recipe agent 506 appears and says “Trust me”. The user-dedicated agent 502 then utters a guide 524 special to the user referring to the acquired request 518. In this example, the user is suffering from anemia and the user-dedicated agent 502 says “Recommend a recipe good for anemia”.

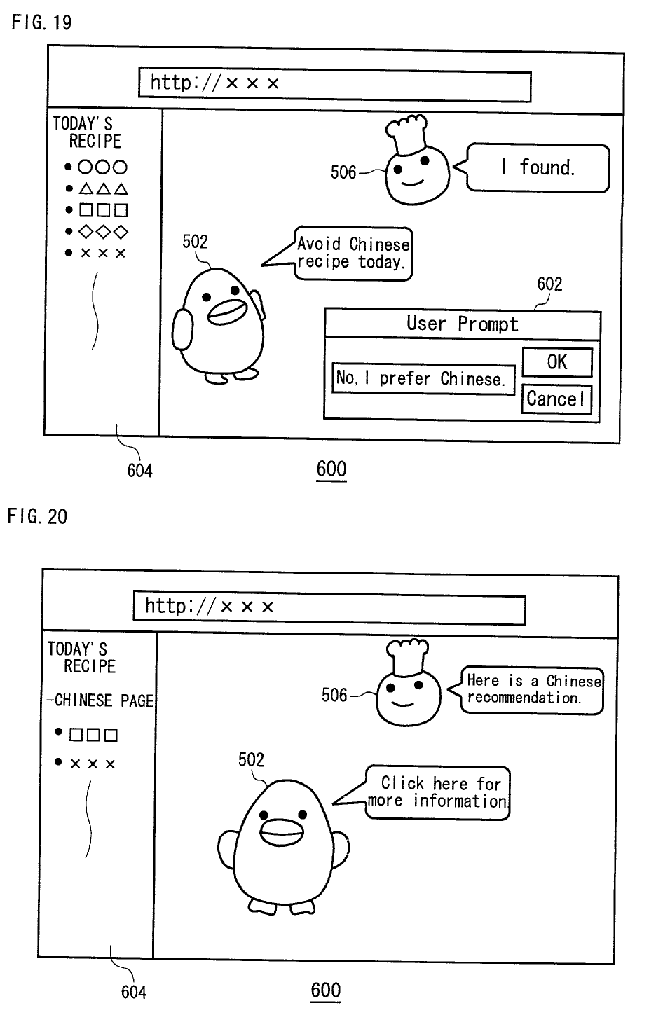

FIG. 19 illustrates the screen 600 when the recipe agent 506 got the search result based on the guide 524. The recipe agent 506 says “I found” and several titles of the recommended recipes are displayed in a search result region 604 as “today's recipe”. The user-dedicated agent 502, detecting that the user has had Chinese food consecutively, gives a new guide 524 saying “Avoid Chinese recipe today”. By this time, the middle processor 14 or the back processor 20 may have started a background process for the search avoiding Chinese food. In this case, however, the user inputs in the input region 602 “I prefer Chinese”.

FIG. 20 illustrates the screen 600 after the secondary search based on the guide 524 is finished. The instruction inputted by the user has higher priority than the guide 524 from the user-dedicated agent 502 and the search is limited for the Chinese food. In this secondary search, the condition regarding the anemia and other conditions may be reflected. After the secondary search, the recipe agent 506 says “Here is a Chinese recommendation”. The recommendation is displayed on the search result region 604. The user-dedicated agent 502 says “Click here for more information”. The user can click the titles of the recipes to directly access to the related sites.

In this example, the user requests a Chinese recipe even after he/she has had Chinese dishes consecutively recently. After a series of search process is finished, the user-dedicated agent 502 may ask the user “You have had Chinese food for three days. Are you really OK?”. If the user answers “Yes”, the search condition concerning the frequency of the same kind of food may be relaxed for the user.

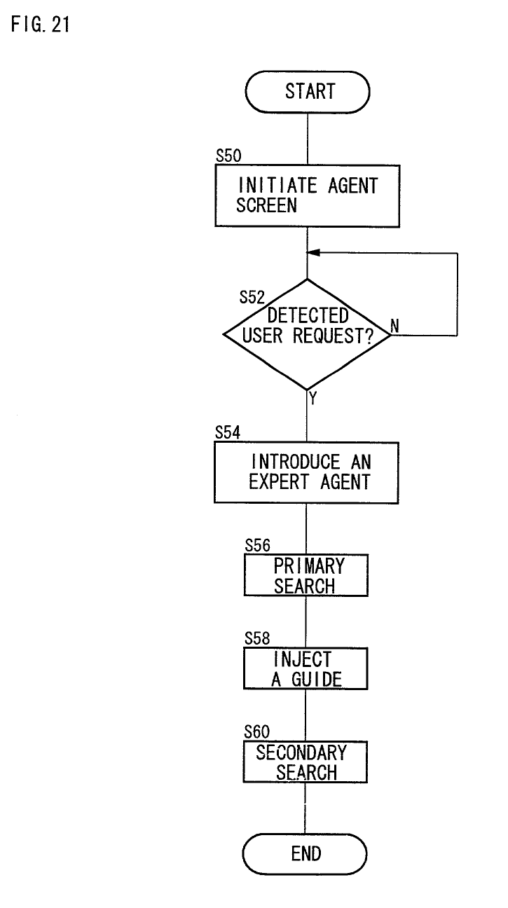

FIG. 21 illustrates the flow of the service provided by the agents. The user initiates the initial screen shown in FIG. 17 (S50). When the user inputs a request for service in the input area 602 via a keyboard or voice (S52Y), the user-dedicated agent 502 calls and introduces an expert agent suitable for the service (S54). The expert agent conducts the initial search based on the request (S56) and displays the search result. The guide 524 is injected to the search (S58) and the secondary search is initiated (S60) to more properly find suitable information, which is displayed. The user can input an instruction at any time during the above steps to modify the service. The guide 524 may be injected when the initial search (S56) is started, to conduct the secondary search (S60) from the beginning. If there are still too many hits in the secondary search, a new guide 524 may be inputted or the user-dedicated agent 502 may ask a few more questions to the user to finally reach the necessary information.

The number of times the user initiated the agent screen may be recorded in the user information DB 150 of the back processor 20. The user-dedicated agent 502 is programmed to passively listen to the user's request until the number reaches a predetermined value. The user-dedicated agent 502 may ask questions more actively on the personal information of the user after the number reaches the predetermined value on the assumption that the user may allow such questions. The user-dedicated agent 502 may, for example, ask “Where do you like to go?”, “How old are you?” and the like and the answers to the questions may be stored in the user information DB 150 of the back processor 20 or the personal information DB 118 of the middle processor 14.

Although Embodiment 1 has been explained with examples, it should be understood that many changes and substitutions may be made by those skilled in the art within the spirit and the scope of the present Embodiment. A few such changes are now described.

The apparatus according Embodiment 1 may be provided with functions for amusement. For example, the user can get points when he/she makes access to the user-dedicated agent 502 or other expert agents. The managing entity of the web server 18 may award a prize to the user when the point reaches a certain value so that the user is encouraged to use the web site, which may become more valuable in terms of advertisement.

“A premium agent” or a special expert agent may be secretly implemented in the apparatus to encourage the user to find the premium agent for amusement or for a present awarded by the site manager.

Expert agents may be local agents. A FAQ expert agent or a mail expert agent may be implemented in the apparatus to help the user operate the apparatus. Local agents are advantageous in that they can work in an off-line environment.

Each expert agent may have a function to record the dialog it had with each user in the user information DB 150 and a function to classify the user to which it is now serving to a specific user type referring to the dialog recorded in the user information DB 150. Expert agents generally can more properly respond to the user after the user is classified into a specific user type.

In another embodiment, the user-dedicated agent 502 may have a function to record user requests in the user information DB 150 and the back processor 20 may have a function to search other users who have similar preference, behavior, life style and the like with the present user based on the past requests stored in the user information DB 150. The search unit 130 may push the same page to the meta information generator 116 of such users.

Embodiment 2

Designing virtual agents is difficult although users do not know the effort of agent designers. Users expect the agents to understand their request properly and to act immediately. It is however difficult to presume all the various user requests and is still more difficult to predict how the users express their request in words, phrases and sentences. Analysis of the request is a hard task.

The present embodiment aims to realize agents which can flexibly respond to various requests from the users. Another purpose of the present embodiment is to provide a user support apparatus to more precisely understand the request of the users. Still another purpose of the present embodiment is to provide a user support apparatus which can improve the preciseness of the understanding of the user requests.

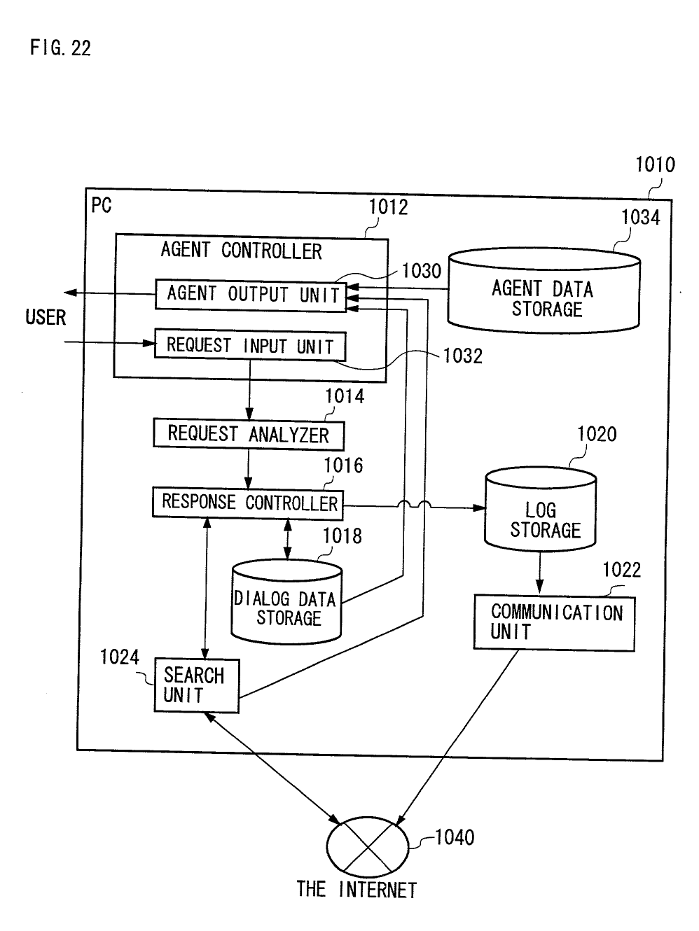

FIG. 22 is a block diagram of a user support system 1010 according to the present embodiment.

The entire configuration can be realized as a stand alone apparatus. In another embodiment, a back end server may comprise arbitrary portions of the apparatus such as an agent controller 1012, a request analyzer 1014, a response controller 1016, a dialog data storage 1018, a log storage 1020, a search unit 1024 and an agent data storage 1034. When the server is provided with a few functional blocks, the remaining functional blocks are implemented in the user apparatus which is a client machine. It is noted that there are many variations how to assign the functional blocks between the server and the client. Now the user support system 1010 is described assuming that it has all the functional blocks shown in FIG. 1 so that it can operate as a basic agent machine even in an off-line environment.

The agent controller 1012 comprises an agent output unit 1030 to display agents to a user and a request input unit 1032 to obtain the requests given from the user to the agents. An agent data storage 1034 holds image data to display agents.

The request analyzer 1014 performs voice recognition on the request uttered by the user and transforms the voice into the corresponding sentence. The request analyzer 1014 then divides the sentence into independent words. For example, when the user utters “Good morning”, the request analyzer 1014 divides the sentence into “Good” and “morning”.

The words thus obtained are sent to a response controller 1016, which determines the response of an agent referring the keywords “Good” and “morning” to a dialog data storage 1018. The dialog data storage 1018 stores conversation data the agent should utter for each major keyword. The response controller 1016, for example, selects “Good morning. How are you?” as the response from the dialog data storage 1018 to answer. The response is sent to an agent output unit 1030, which conveys “Good morning. How are you?“by the action, voice of the agent or by a sentence.

When the user request such as “Tell me the weather tomorrow” makes it necessary to search for a specific information, the response controller 1016 transfers the keywords such as “tomorrow” and “weather” to a search unit 1024, which acquires weather forecast via the Internet 1040. At the same time a fixed sentence “It will be . . . tomorrow”, is read from the dialog data storage 1018, which is sent to the i15 agent output unit 1030 together with the information obtained via the Internet 1040. The agent output unit 1030 may utter “It will be cloudy tomorrow” to the user.

The response controller 1016 cannot always understand the user request. The response controller 1016 may not be able to find a suitable conversation data in the dialog data storage 1018 when the user inputted an unexpected request. In such a case, the response controller 1016 records the request as an unattained request in a log storage 1020 and reads a formatted apology “I'm sorry, I cannot understand well” from the dialog data storage 1018 to thereby send it to the agent output unit 1030 as an error handling process. The agent output unit 1030 utters the apology to the user. The minimum information the log storage 1020 should record is the unattained request. In FIGS. 9 and 10 described later, all the interaction between the user and the apparatus is recorded in the log storage 1020 as the history of the interaction is sometimes useful in reality.

A communication unit 1022 reads the unattained requests from the log storage 1020 and sends them to an arbitrary manager, not shown, via the Internet using an electric mail periodically or when an unattained request occurs or when the number of the unattained requests reaches a predetermined value. The system manager may reside within the same site as the user support system 1010. The manager registers each unattained request and its corresponding response to the dialog data storage 1018 to thereby improve the function or performance of the agents.

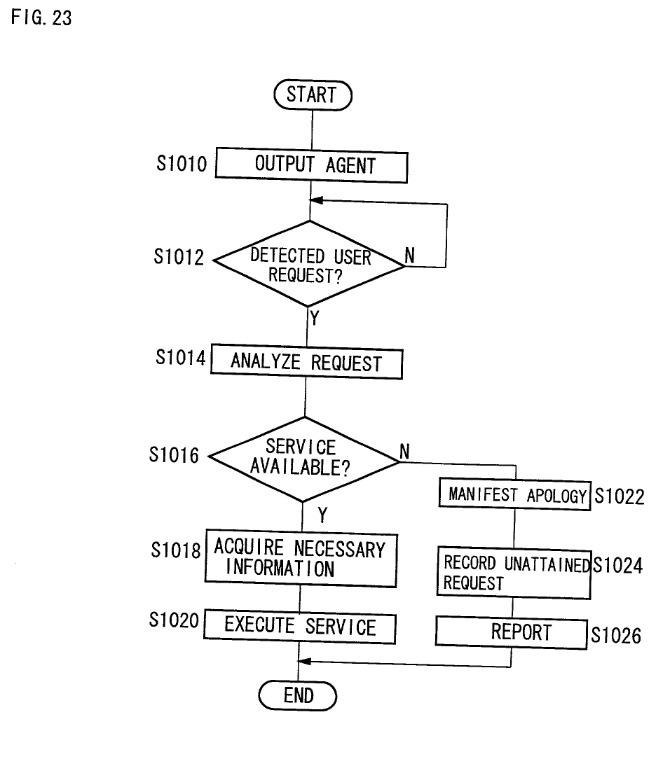

FIG. 23 illustrates the flow of service performed by an agent in the user support system 1010. When the user support system 1010 is powered on, the agent output unit 1030 outputs an agent to the user (S1010). The request input unit 1032 waits for a user request (S1012). When a request is inputted (S1012Y), the request analyzer 1014 decomposes the request into words (S1014). The words are transmitted to the response controller 1016, which judges whether the service is possible or not (S1016). The service is judged to be possible when a suitable conversation data is found in the dialog data storage 1018 (S1016Y). Necessary information for the service is acquired from the dialog data storage 1018 and, if necessary, by the search unit 1024 (S1018). The service is performed via the agent output unit 1030 (S1020).

On the other hand, when the response controller 1016 judges the service not to be possible or when it cannot understand the user's request (S1016Y), it reads a formatted apology from the dialog data storage 1018 to make the agent output unit 1030 utter the apology (S1022) and records the request as an unattained request to the log storage 1020 (S1024). The communication unit 1022 transmits the unattained requests to the system manager (S1026).

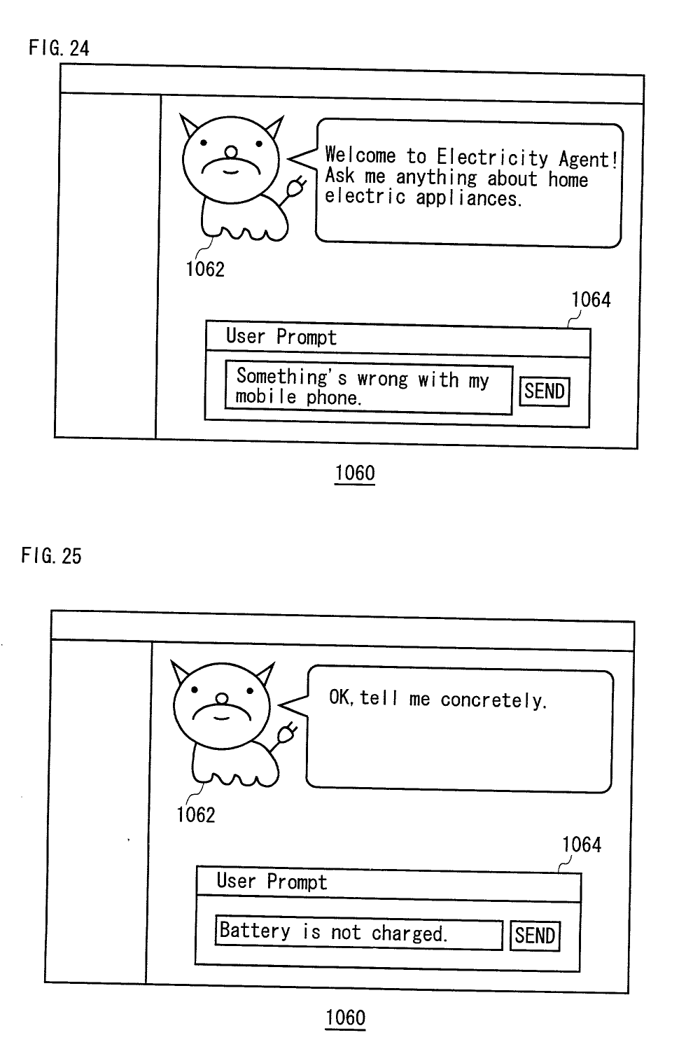

FIGS. 24 to 29 show an example of the interruption between the user and an agent. In FIG. 24, Electricity Agent 1062 which is in charge of services regarding electricity related matters appears on the screen 1060 and accepts user questions as to electric appliances. The user inputs a request such as a question in an area 1064. The user inputs “Something's wrong with my mobile phone”.

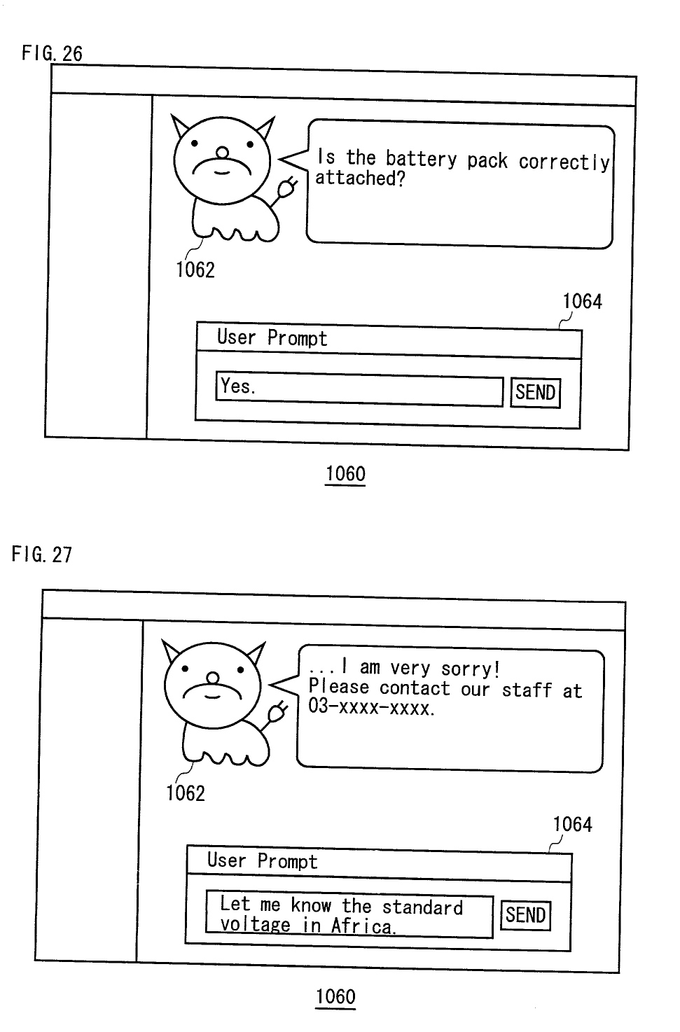

Electricity Agent 1062 answers “OK, tell me concretely” as shown in FIG. 25. The user inputs “Battery is not charged”. The first check point for this problem is read from the dialog data storage 1018 and Electricity Agent 1062 asks “Is the battery pack correctly attached?“as shown in FIG. 26. The user answers “Yes” to this question. Then the next check point is confirmed. In this example therefore the function of Electricity Agent 1062 is an embodiment of so-called FAQ for electric appliances.

FIG. 27 shows the response of Electricity Agent 1062 when it could not understand the request. In this case, the user wants to know his/her electric devices can operate in Africa before the trip and asks “Let me know the standard voltage in Africa”. Electricity Agent 1062 is, however, not designed to cope with such a question and cannot find a suitable answer in the dialog data storage 1018. The user request is recorded as an unattained request in the log storage 1020. Electricity Agent 1062 answers ”. . . I am very sorry! Please contact our staff at 03-xxxx-xxxx” to hand over the question to a human operator. The system manager, viewing the unattained request, can implement the voltage information in each country in the dialog data storage 1018 to thereby continuously improve the FAQ.

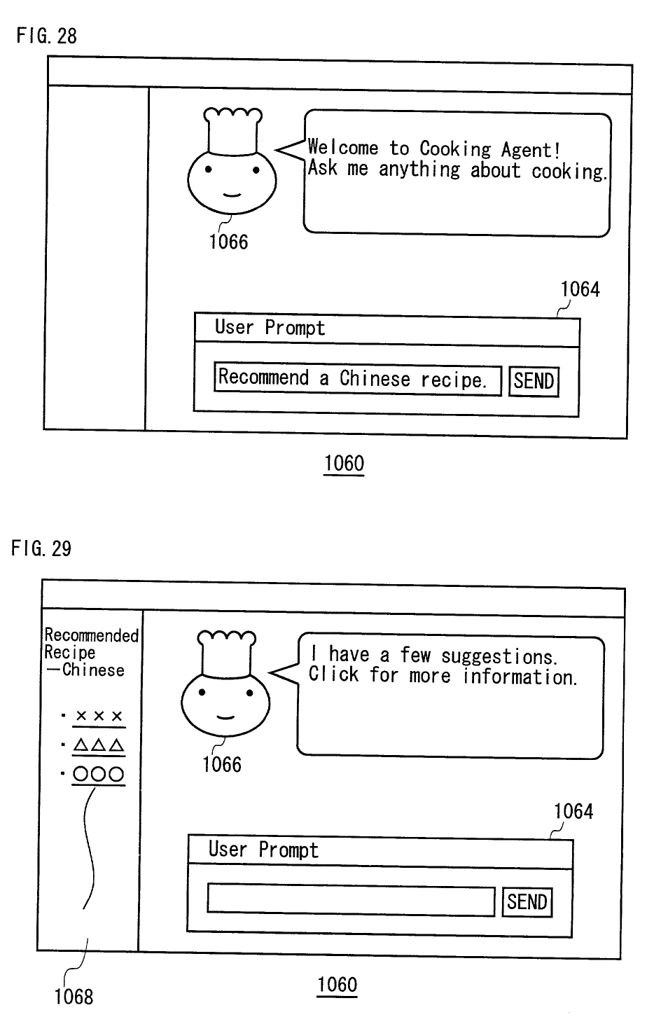

FIG. 28 shows a scene for information search. Cooking Agent 1066 for providing information regarding cooking especially recipe to the user appears on the screen. The user inputs a request “Recommend a Chinese recipe”. Cooking Agent 1066 searches for recommendation through the search unit 1024 and displays the recommended items in a search result area 1068. The user can click the items displayed in the area 1068 to acquire more information via the Internet 1040. In this situation, if the user inputs a question “Let me know a typical recipe in the ancient Rome”, this request will probably be recorded as an unattained request. The manager can review the information regarding recipe from various views and can improve the content of the dialog data storage 1018.

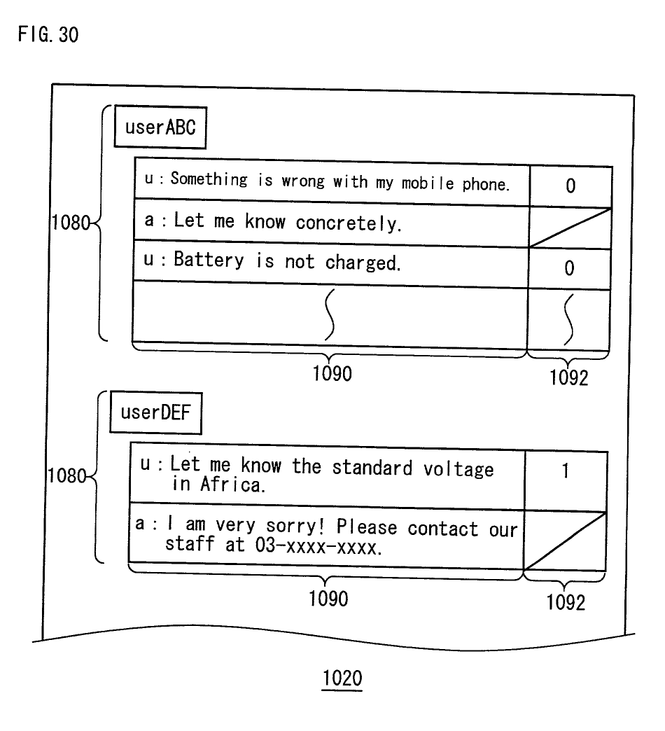

FIG. 30 shows the internal structure of the log storage 1020. The log storage 1020 records all the conversation session 1080 between the user and the agent. In FIG. 30, conversation sessions 1080 for “userABC” and “userDEF” are shown. When the user support system 1010 is a standalone type, it can create a history of multiple users by admitting login of the users. When the log storage 1020 is implemented in the back end web server, it can record a history of multiple users of multiple user support systems 1010.

The conversation session 1080 further comprises a dialog record column 1090 and an unattained flag column 1092. In the former column, “u” and “a” stand for the utterance of the user and the agent, respectively. In the latter column, the flag is set to one when the request is an unattained and is set zero otherwise.

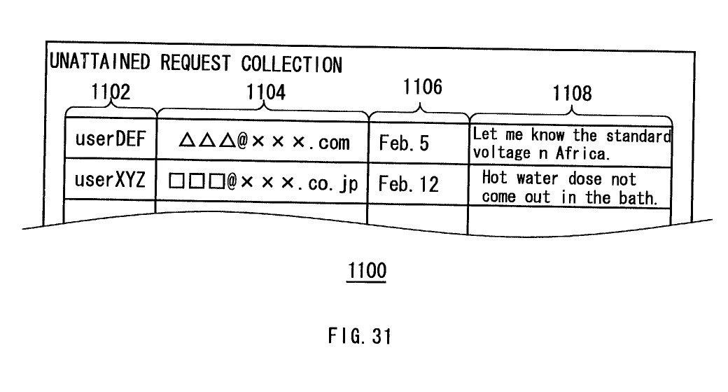

FIG. 31 illustrates an unattained request list 1100 generated by the communication unit 1022. The list 1100 comprises a user column 1102 to record the names of users who inputted unattained requests, a mail address column 1104, a date and time column 1106 to record when the unattained request occurred, and a full sentence column 1108 to store the entire sentences of the unattained requests. The system manager, after checking the unattained requests, may answer to the users with electronic mails.

Embodiment 2 is described. Embodiment 2 also has various modifications.

In one embodiment, the response controller 1016 may check the full sentence of the user's request directly against the dialog data storage 1018. In this case, unattained requests may be registered as a whole sentence such as “Let me know the standard voltage in Africa” together with the suitable response for the request.

Embodiment 3

Embodiment 3 aims to provide a technique to realize interaction among a plurality of agents or characters from a different technical view. According to Embodiment 3, characters which have been created entirely independently can have interaction. This embodiment also provides a technique to efficiently develop such agent functions.

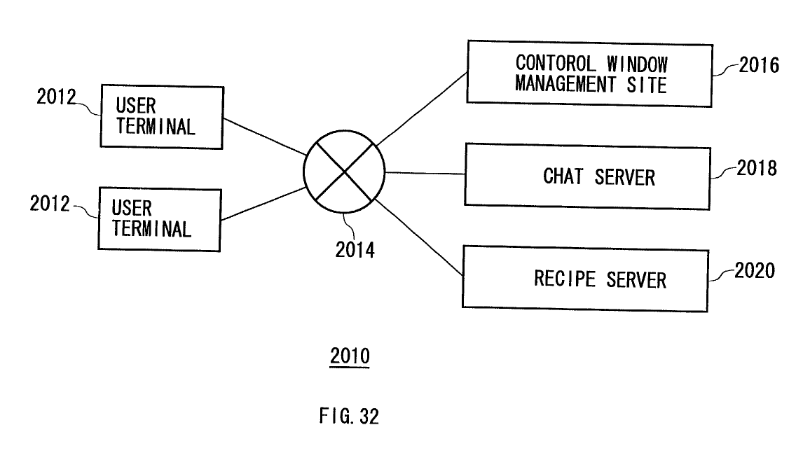

FIG. 32 shows the entire configuration of the user support system 2010 according to Embodiment 3. A user terminal 2012, a control window management site 2016, a chat server 2018 and a recipe server 2020 are connected via the Internet 2014. The control window management site 2016, the chat server 2018 and the recipe server 2020 are servers in a broad sense of the word.

The chat server 2018 and the recipe server 2020 are in charge of respective specialized areas so that they interpret user utterance and process the actions of agents. The chat server 2018, for example, processes greetings such as “Hello”, whereas the recipe server 2020 processes utterance concerning recipe such as “Let me know a good recipe”. By assigning specialized functions to each specialized server, the whole process can be divided and distributed so that the maintenance of each agent becomes easier.

The chat server 2018, the recipe server 2020 and the like are collectively referred to as “specialized” servers or “expert” servers and the agents put in the specialized servers are referred to as “expert” agents. The control window management site 2016, the chat server 2018 and the recipe server 2020 may be realized in different nodes on the network. Alternately, the control window management site 2016 may be implemented in the chat server 2018, which may be designed as the originating server to handle the interaction with the user terminal 2012. The example below is described on the latter assumption.

The basic process in FIG. 32 is as follows. The user terminal 2012 first connects to the control window management site 2016. The site 2016 comprises a total management function to manage a plurality of agents, and a character management function to manage a plurality of characters simultaneously. These functions are referred to as “horizontal functions” hereinafter. The horizontal functions, which are characteristic of the present embodiment, work as a bridge to allow different agents to interact having conversation. The site 2016 transmits a program to realize the horizontal functions to the user terminal 2012, which then enjoys the horizontal function even in an off-line environment.

The user terminal 2012 then connects to the chat server 2018 to receive a specific service. The chat server 2018 is specialized for chat and comprises an agent control function to realize the chat service and a character control function to work for the same purpose. These specialized functions are referred to as “expert functions” or “specific purpose functions”. The specific purpose functions are designed to and implemented in each expert server. The recipe server 2020 has the specific purpose functions regarding recipe. Specialized servers may be provided for a travel agent, a PC agent and the like in which users may be interested.

The user first talks to the chat agent to request an arbitrary service. The chat agent acquires and interprets the user utterance. When the utterance relates to recipe, the chat agent calls the total management function to make the recipe agent appear on the screen. The total management function divides the screen of the user terminal 2012 into two frames in which the chat agent and the recipe agent are put separately. The two agents have interaction including greetings and the like. For this purpose, the horizontal function is called. The interface between the horizontal function and specific functions is predefined. It becomes possible for each agent to talk to another agent as log as the agent is designed on the interface. The interaction with another agent is not possible without the horizontal function. The agent must respond to another agent when it is talked to. To this end, functions according to the interface must be implemented in the agent so as to take actions responsive to the total management function. The agents can be put in windows instead of the frames throughout this specification.

Various functions so far described are realized in the form of program functions. For this purpose, the main developer of the entire user support system 2010 or the “leading developer” first implements the horizontal function in the control window management site 2016 as the basic framework of the entire system, and informs designers of expert agents or “general developers” of the horizontal function. The general developers can know the horizontal function which they can use, and the format and content of each function. The leading developer, on the other hand, decides the content of program functions to realize specific functions of each agent so that the horizontal function can issue instructions to each agent. The general functions must implement the program functions informed by the leading developer. The “interface” may be regarded as the whole specification regarding the program functions described above.

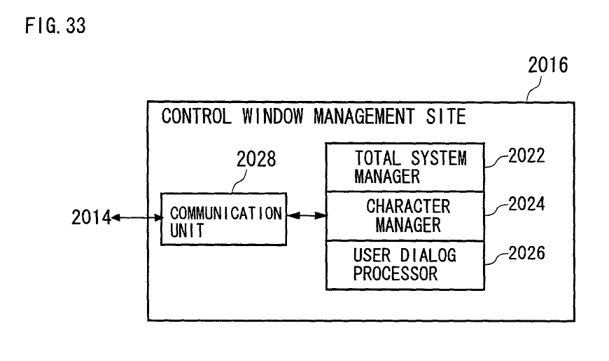

FIG. 33 illustrates the internal structure of the control window management site 2016. The control window management site 2016 comprises a total system manager 2022, a character manager 2024, and a user dialog processor 2026, each of which communicates with the user terminal 2012 via a communication unit 2028 and the Internet 2014. The total system manager 2022 realizes the horizontal function at the agent level. Similarly, the character manager 2024 realizes the horizontal function at the character level. The user dialog processor 2026 displays a user input prompt on the screen of the user terminal 2012 and acquires letters inputted by the user. The functions of the control window management site 2016 may be downloaded to the user terminal 2012 beforehand and may work inside the user terminal 2012.

The total system manager 2022 provides a field to realize the interaction among a plurality of agents and manages the agents totally. The substance of the total system manager 2022 in this embodiment is an HTML file, in which program functions described in a script language include the following ones.

AddAgent( ): add a new character to the field,

Bcast( ): inform all the characters displayed of an information item,

Tell( ): inform one agent of an information item,

ReqUI( ): request the chat agent to acquire user information,

ReqPr( ): request the user input prompt to be displayed.

In these functions, attributes such as target information and target agent may be described. These functions are provided as standard functions, which the general developers can use when designing an agent. The total system manager 2022 also manages Cookies to be set in the browser of the user terminal 2012.

The character manager 2024 provides a basic function to visually express the interaction among the agents at the character level. The character manager 2024 is also an HTML file in which functions are written in a script language. Some examples of the functions are as follows.

WalkClose( ): move to a specified character,

PointWin( ): point at a specified window,

Talk( ): talk to a specified character.

These functions are also provided as standard functions. To realize these functions, the character manager 2024 has a function to detect the positions of all the characters.

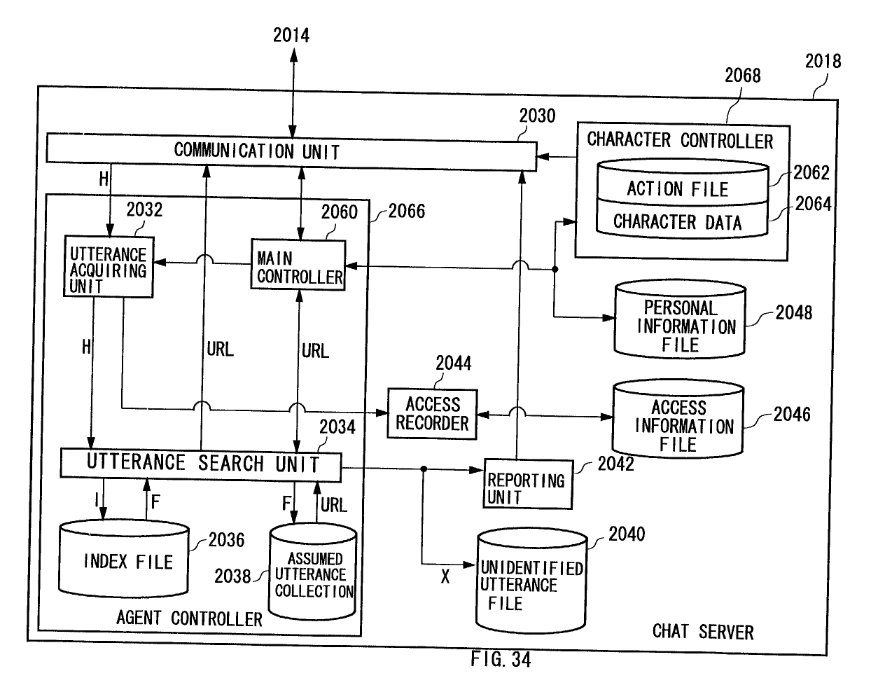

FIG. 34 shows the internal structure of the chat server 2018. In this figure, “H”, “I”, “F” and X” stand for utterance data, index search for utterance, a file name containing the URL of the page of the expert server which should respond to a specified user utterance, and unidentified utterance, respectively.

An agent controller 2066 obtains and interprets a user request via a character so that the substantial function of an agent is realized. A character controller 2068 provides a series of basic functions of a character used by the agent controller 2066. At least one set of the agent controller 2066 and character controller 2068 is implemented in each specialized server to conduct a specialized service. A communication unit 2030 enables communication between the agent controller 2066 and the character controller 2068 with the user terminal 2012 via the Internet 2014.

The agent controller 2066 has a series of functions to respond to the utterance of the user or other agents, which are hereinafter referred to simply as “target utterance”. A main controller 2060 controls a series of processes mainly conducted by an utterance acquiring unit 2032 and the character controller 2068. The essential function of the main controller 2060 is to specify a page which should respond to each target utterance and moves to the page. The utterance acquiring unit 2032 acquires the target utterance from the user terminal 2012 and sends it to an utterance search unit 2034. The utterance search unit 2034 first conducts an index search by verifying the first letter or word of the target utterance in an index file 2036. After the index search, the utterance search unit 2034 specifies the target utterance by conducting a phrase search considering the entire target utterance. In the phrase search, not only the words but also the order of the words are considered. When the target utterance cannot be found by the phrase search, the utterance may be divided into words and keyword search may be conducted.

The index file 2036 contains in an alphabetic order assumed or anticipated utterances which are stored in an assumed utterance collection 2038 to specify the target utterance. It is generally possible to conduct a fast search by referring the first letter or word to the index file 2036 even when the assumed utterance collection 2038 is large. As described later, in this embodiment, the assumed utterance collection 2038 is easily expanded and the fast search realized by the index search is beneficial.

When the target utterance is specified in the index file 2036, a file containing the URL and the like of the specialized server to respond to the target utterance is specified in the index file 2036. The file stored in the assumed utterance collection 2038 is then opened and the URL is acquired. Each target utterance has one file in the assumed utterance collection 2038.

When the URL is within the chat server 2018 itself, the URL is transmitted to the main controller 2060, which sends the URL to the browser of the user terminal 2012 via the communication unit 2030.

When the URL is within another specialized server, the URL is set to the browser of the user terminal 2012 and the user terminal 2012 accesses the specialized server. To be more precise, the URL points not the home page of the specialized server but a specific independent page to directly respond to the target utterance. Each utterance has at least one corresponding page in this embodiment.

It is naturally desirable that the target utterance has its complete copy in the assumed utterance collection 2038. During the improving process of the assumed utterance collection 2038, however, the target utterance does not necessarily have its perfect copy in the assumed utterance collection 2038. In that case, the utterance search unit 2034 seeks the most probable utterance in the assumed utterance collection 2038 decomposing the utterance into words and retrying search inputting logical AND of the words especially nouns. The target utterance which could not be found or which was found only in the retry search is recorded in an unidentified utterance file 2040 as an unidentified utterance, which is transmitted to the system manager by an e-mail via the reporting unit 2042.

The system manager requests the manager of the specialized server which should have responded to the unidentified utterance to improve the response process conducted by the expert agent. The manager of the specialized server registers the unidentified utterance and the URL of a page of the specialized server which should respond to the unidentified utterance, in the assumed utterance collection 2038 within the specialized server, registers the index of the utterance in the index file 2036, and designs the process including the action of the expert agent realized with the page. In this maintenance, an unidentified utterance can be easily added in the assumed utterance collection 2038 and it is generally easy to improve the content of the assumed utterance collection 2038.

The main controller 2060 also manages a personal information file 2048. The personal information file 2048 may be managed only by the chat server 2018 among a plurarity of specialized servers as the chat server 2018 frequently has conversation with the user and is suitable to acquire the personal information of the user. The main controller 2060, for example, may be implemented with a program function to periodically ask the user information, such as the age of the user and other attributes and the preference on foodstuff and the like. Answers from the user may be recorded in the personal information file 2048. Other agents can request to acquire the personal information using the aforementioned program function ReqUI( ). The personal information may be used when specialized servers perform services to the user. In this embodiment, the chat agent may issue an instruction instead of the user when another agent conducts a service to the user. Agents interact during the process.

The main controller 2060 may be implemented with the program functions below.

Respond( ): is called when a character is clicked and describes a proper process to the click,

Listen( ): acquires information when transmitted from another agent.

Implementation of these functions is entrusted to the general developer of the chat server 2018. These functions are called from the total system manager 2022, the character manager 2024 and the like.

A character controller 2068 comprises an action file 2062 to describe the actions of a character to respond to each target utterance, and a character data 2064 to store the image data and voice data of the character. The character data 2064 is first downloaded to the user terminal 2012 and can work within the user terminal 2012.

The character controller 2068 is, for example, implemented with the below program functions.

ComeOut( ): makes characters appear on the screen,

Act( ): makes a character play a designated action,

Spk( ): displays a designated text in a window and outputs voice data according to the text,

Goout( ): makes a character disappear on the screen,

Halt( ): Freezes all the characters.

The basic action of a character is realized with the above functions. The development of these functions is also entrusted to the general developers. These functions are also called from the total system manager 2022 and the character manager 2024.

An access recorder 2044 records the access history of each user to the specialized servers in an access information file 2046. By this configuration, a response to the same user utterance may be made different to each user. For example, when a user first visits the chat server 2018 and says “Hello”, the chat agent answers “Hello. Nice to meet you”. When the user revisits the chat server 2018, the chat agent may answer “Hello, how are you getting along?” to act more properly according to the situation. The access recorder 2044 informs the utterance search unit 2034 of the access history of the user. The utterance search unit 2034 selects a page suitable for the present situation and sends the URL to the browser of the user terminal 2012 when it found a plurality of pages of a specialized server to respond to the target utterance in the assumed utterance collection 2038 just like the above example.

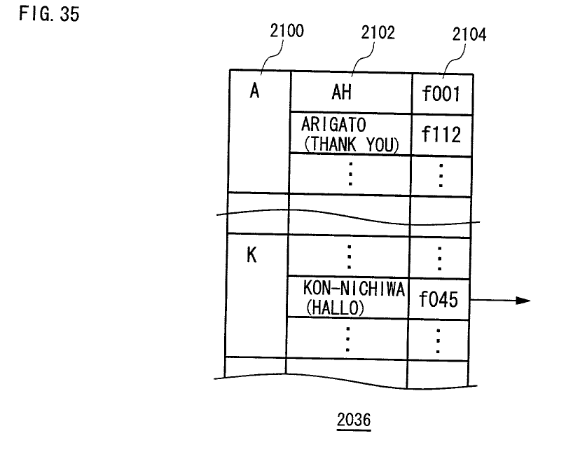

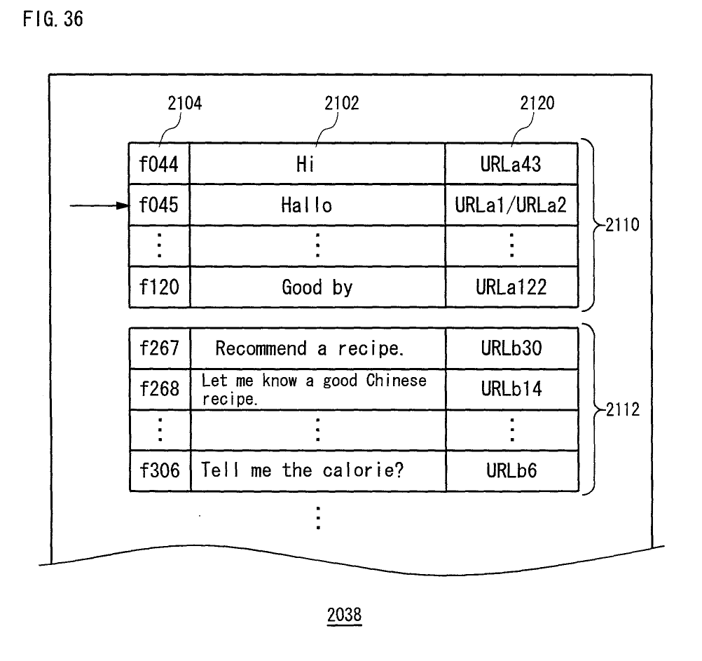

FIG. 35 shows the internal structure of the index file 2036. FIG. 36 shows the internal structure of the assumed utterance collection 2038. The index file 2036 comprises an alphabetic column 2100, a target utterance column 2102 and a file name column 2104. The target utterances are sorted in the alphabetic order noting the first letter of the utterance.

The assumed utterance collection 2038 comprises a file name column 2104, a target utterance column 2102 and a page column 2120 to indicate the page of the specialized server to respond to the target utterance. For example, when the user utterance is “Hi”, the page of the specialized server is “43”. The combination of “Hi” and “URLa43” composes the file f044. The target utterances are classified to each specialized server. A user utterance collection 2110 of which the chat server 2018 should take care and a user utterance collection 2112 of which the recipe server 2020 should take care, for example, are generated independently. The index file 2036 and the assumed utterance collection 2038 are linked together with file names. “Hello” corresponds to the file f045 in the index file 2036, which in turn corresponds to the file f045 of the assumed utterance collection 2038.

As shown in the index file 2036, ” Hello” has two corresponding pages URLa1 and URLa2. The URLa1 is sent to users who first visit the chat server 2018 and URLa2 is sent to users who revisit the chat server 2018.

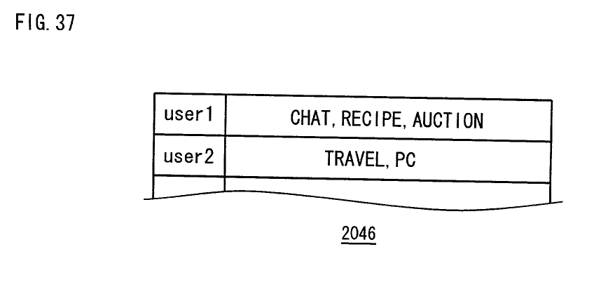

FIG. 37 shows the access information file 2046. “User 1” has visited “chat”, “recipe” and “auction” servers. “User 2” has visited “travel” and “PC” servers. In this situation, when the user 2 visits the chat server 2018, the chat agent selects an utterance for the first visitor, and when user 1 visits the chat server 2018, the chat agent selects an utterance for a revisitor.

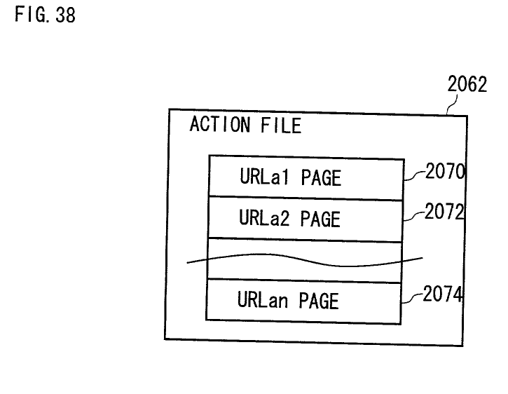

FIG. 38 shows the internal structure of the action file 2062. URL specified in the utterance search unit 2034, such as the URLa1 or URLa2 in case of “Hello” shown in FIG. 36, is inputted to the action file 2062 via the main controller 2060. In the action file 2062, each URL specified at the utterance search unit 2034 is corresponded to each page, for example, URLa1 to page 70, URLa2 to page 72 and URLan to page 74 so that multiple pages are bundled. Each page is a Web page and is provided for each target utterance to achieve system flexibility.

The content of a page contained in the action file 2062 is now described. The name of a page is “AC.html” and has a function to load and display a standard character provided by a certain OS under the name of “AChara”. The character speaks when the function Spk is called from outside.

<html>
<head>
<title>TEST</title>
<meta http-equiv=“Content-Type” content=“text/html;
charset=Shift_JIS”>
</head>
<body bgcolor=“#FFFFFF”>
<!--declaration and load of Agent of company x-->
<OBJECT ID=“AgentControl” CLASSID=“xxx” CODEBASE=“#VERSION=
2,0,0,0”>
</OBJECT>
<SCRIPT language=Javascript>
var AChara;
Agent.Characters.Load(“AChara”,
“C:¥¥XXX¥¥Xagent¥¥CHARS¥¥AChara.acs”);
AChara=Agent.Characters.Character(“AChara”);
AChara.ComeOut( );
</SCRIPT>
<SCRIPT language=JavaScript SRC=“AC.js”></SCRIPT>
</body>
</html>

A script file is used. The character speaks using the function, which collectively stands for HTML files and functions written in script languages. The script file is as follows.

function SPK(spText) {

AChara.Speach(spText);
}

When the name of a frame in which AC.html is displayed is “aFrame”, it becomes possible to make AChara speak from outside by writing as follows.

aFrame.Spk(“Good-bye”);

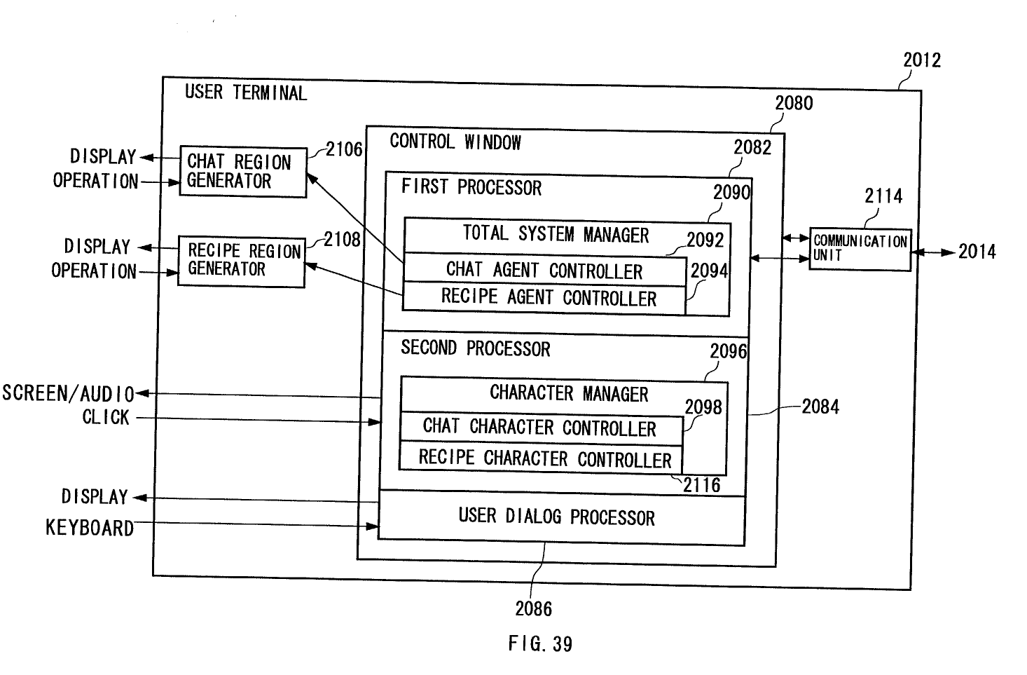

FIG. 39.illustrates the internal blocks of the user terminal 2012. Each function of the user terminal 2012 may be provided from the control window management site 2016, the chat server 2018, the recipe server 2020 and other expert servers, may be pre-installed in the user terminal 2012 or may be downloaded from the control window management site 2016 when the user terminal 2012 is first connected to the site 2016 and is held locally. In other words, when the user support system 2010 is realized with the user terminal 2012, the site 2016 and other servers, each function for process may be installed in the client or in the server or in any other locations. As a general rule, functions which should be less frequently updated or which need no updating may be pre-installed in the client.

A communication unit 2114 communicates with the control window management site 2016 and the like via the Internet 2014. A control window 2080 comprises a first processor 2082, a second processor 2084 and a user dialog processor 2086. The first processor 2082 comprises a total system manager 2090, which manages a chat agent controller 2092 and a recipe agent controller 2094. The total system manager 2090, the chat agent controller 2092 and the recipe agent controller 2094 correspond to the total system manager 2022 of the control window management site 2016, the agent controller 2066 of the chat server 2018 and an agent controller (not shown) of the recipe server 2020, respectively. The chat agent controller 2092 and the recipe agent controller 2094 manage a chat region generator 2106 and a recipe region generator 2108 to display the result of services, respectively. The second processor 2084 comprises a character manager 2096, which manages a chat character controller 2098 and a recipe character controller 2116. The character manager 2096, the chat character controller 2098 and the recipe character controller 2116 correspond to the character manager 2024 of the control window management site 2016, the character controller 2068 of the chat server 2018 and a character controller (not shown) of the recipe server 2020, respectively. The user dialog processor 2086 corresponds to the user dialog processor 2026 of the control window management site 2016. The first processor 2082 and the second processor 2084 refer to the information inputted in the user dialog processor 2086.

The above functions, which have been described with regard to FIGS. 33 and 34, can be viewed from the user. The chat region generator 2106 and the recipe region generator 2108 display information to the user and accept instructions and other operations from the user. The second processor 2084 provides information in a visible or audible manner and accepts user operations such as clicks. The user dialog processor 2086 displays a user input prompt and accepts character input.

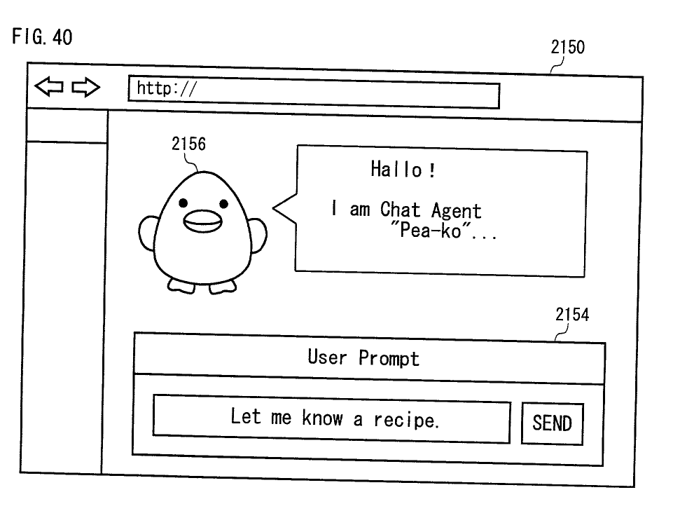

Now the interaction between the user and agents and among agents is described. FIG. 40 illustrates a screen 2150 displayed when the user initiates the user terminal 2012. A character 2156 of the chat agent, which is hereinafter referred to as “Chat Agent” 2156, appears and speaks “Hello! I am Chat Agent Pea-ko”. The user inputs “Let me know a recipe” in an input region 2154 and clicks a SEND button. The input area 2154 may appear when the user clicks Chat Agent 2156. Chat Agent 2156 may talk to itself or ask a question to the user to encourage the user request until the user clicks it.

Inputted “Hello” is acquired by the user dialog processor 2086 and is analyzed by the chat agent controller 2092. The chat agent controller 2092 has inside a copy of the function of the agent controller 2066 in the chat server 2018 and specifies a page in the action file 2062 of the character controller 2068 to respond to the user. The page may be identified in the action file 2062 of the character controller 2068 or in the chat character controller 2098 of the user terminal 2012. In this example, the target utterance relates to recipe and a process “Call a recipe agent on the screen” is described in the specified page for the response. More concretely, a program function ADDAgent( ) prepared by the total system manager 2022 is written in the HTML file beforehand. That is, a horizontal function at the agent level is used to bridge different agents when the process executed by an agent relates to another agent.

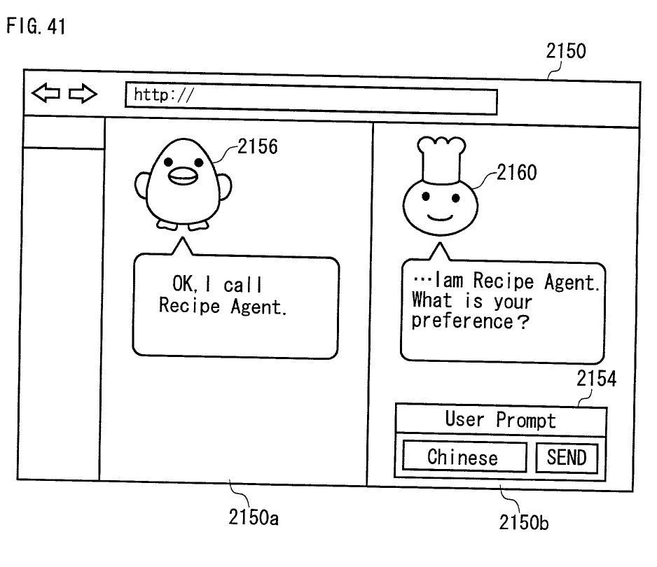

FIG. 41 shows a screen 2150 appearing after the above process. The total system manager 2090 divides the screen 2150 into a first frame 2150a and a second frame 2150b. Chat Agent 2156 is placed in the former and Recipe Agent 2160 is placed in the latter. Before Recipe Agent 2160 is called, Chat Agent 2156 says “Now, let's call Recipe Agent . . . ” to the user. Recipe Agent 2160 on the other hand asks “I am Recipe Agent. What is your preference?“to the user when it is called. The utterance of Chat Agent 2160 is realized by the recipe agent controller 2094 and the recipe character controller 2116 using a program function such as Spk( ) to make a character speak written in a page (not shown) to respond to the user. The user then inputs “Chinese” in the input region 2154 and sends it to the server.

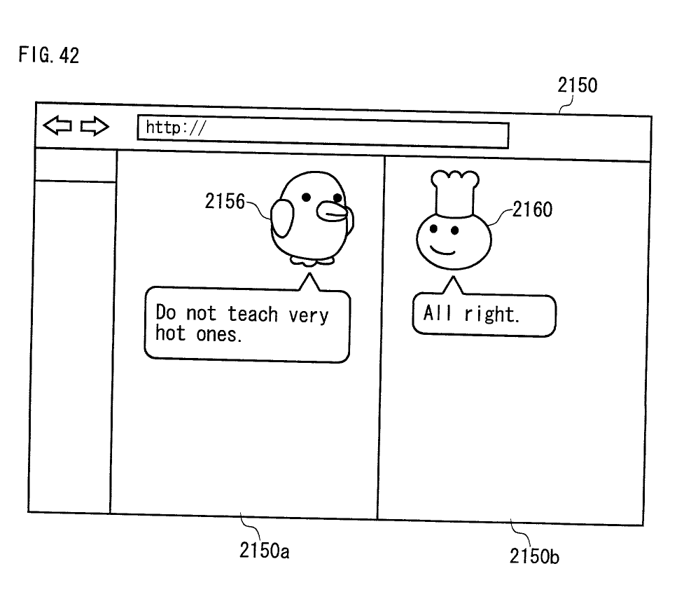

FIG. 42 shows the screen 2150 after the above process. Chat Agent 2156 interprets that the utterance of Recipe Agent 2160 relates to the introduction of a dish. The chat character controller 2098 specifies a page to respond to the utterance. In the page, the note “Advise the agent presently speaking not to recommend hot dishes” is described. Chat Agent 2156 comes closer to Recipe Agent 2160 and talks “Do not teach very hot ones” as a request. For this purpose, aforementioned WalkClose( )and Talk( ) are written in the page of Chat Agent 2156. Recipe Agent 2160 on the other hand accepts the advice as “utterance of another agent”, interprets the utterance and specifies a page to respond. In the page, for example, the note “Obey the request. Search for a recipe without chili sauce” is written. In this case also, the function Talko is used to make Recipe Agent 2160 and Chat Agent 2156 face each other. In the background process, the chat agent controller 2092 executes search using a search condition or a firmula such as

(“recipe” OR “menu”) AND “Chinese” AND “recommendation” AND /“chili sauce”,

where “/” is a NOT operator. The preference of the user is recorded beforehand in the personal information file 2048.

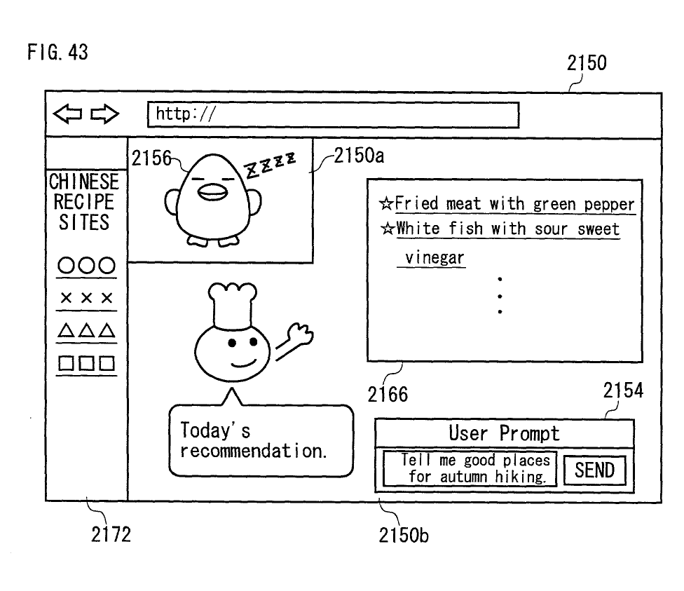

FIG. 43 shows the screen 2150 containing the search result by Recipe Agent 2160. Recipe Agent 2160 says “Today's recommendation”. The search result is displayed in a recipe window 2166 generated by the recipe region generator 2108. The search result is displayed with titles which are linked to details. Sites containing Chinese recipe found by the search are displayed in a search result area 2172 by the recipe agent controller 2094 for the reference. Chat Agent is asleep as it has not been talked to. Pages may be designed to respond not only to the content of the target utterance but also to the interval or other states of the utterance.

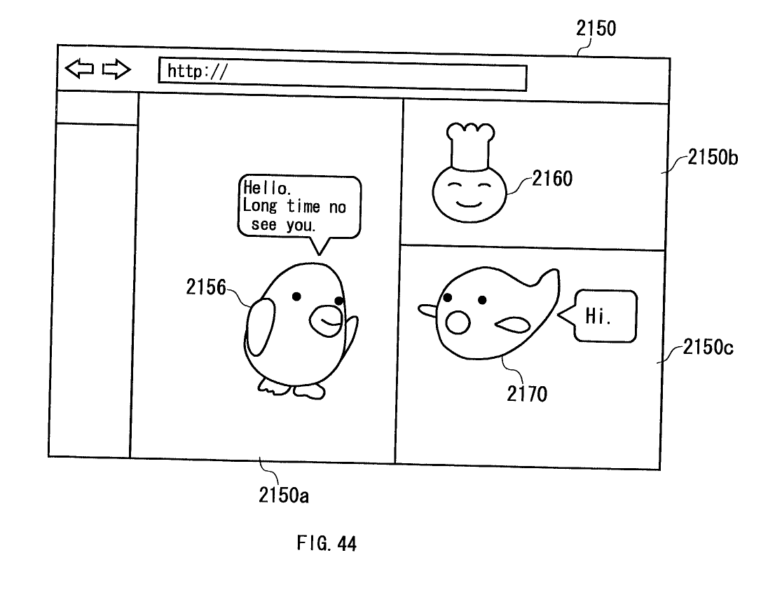

In FIG. 43, the user further inputs a question “Tell me good places for autumn hiking”. FIG. 44 shows the screen 2150 appearing after the question is inputted. In the screen, a third frame 2150c is created and Travel Agent 2170 appears in the frame. Chat Agent 2156 talks to Travel Agent 2170 “Hello. Long time no see you.” and Travel Agent 2170 answers “Hi”. The interaction between different agents here is also realized by the aforementioned program functions or the like.

The effect of the present embodiment is as follows.

Different agents provided from different companies or creators can have interaction by standardizing the interface at a program function level. Agents which have completely different output formats such as a 3D polygonal character written in VRML (Virtual Reality Modeling Language), a 2D character in JPEG (Joint Photographic Expert Group) and an arbitrary bit map character the user created with a digital camera can have conversation on the same screen and thereby can provide an exquisite agent apparatus.

By adopting a standardized interface, the leading developer can effectively collaborate with general developers or the third parties. The leading developer develops the control window management site 2016 and the general developers develop expert agents. The number of expert agents can be increased relatively easily in accordance with the user request by designing each agent in a modular manner.

A few modifications are now described. The user terminal 2012 may be pre-installed with a plurality of expert agents which are frequently used. The user terminal 2012 may download such agents beforehand. In that case, if an agent which should be called after the interpretation of the utterance by Chat Agent 2156 exists inside the user terminal 2012 from the beginning, the process by Chat Agent 2156 is made unnecessary and the expert agent may appear immediately on the screen 2150 without the help of Chat Agent 2156. Such expert agents may be hidden in the user terminal 2012 even when they exist therein.

The control window 2080 may be a conceptual framework provided by the control window management site 2016. In actual implementation, however, the control window 2080 may be provided visibly or invisibly, linked with an arbitrary object or a region on the screen 2150. The control window 2080 may be set on the entire screen 2150 in an invisible manner so that Chat Agent 2156 appears when the user clicks on an arbitrary portion of the screen 2150.

The target utterance may be acquired via voice recognition. Users may feel it more natural to input their request via voice.

An unidentified utterance is described as an utterance which could not be specified in the assumed utterance collection 2038. The unidentified utterance, however, may be one which could be specified in the assumed utterance collection 2038 but to which the expert agent could not properly respond. For example, when the target utterance is “Let me know a recipe”, the search result may contain to many information items. In this case, the user eventually cannot find desired information. Such a target utterance may be sent to an expert agent manager so that the expert agent is improved.

Utterance from an expert agent has been selected based on the access history of the user to each expert server. The utterance may be further selected based on the attribute information of the user. The expert agent may select a more gentle expression when the user is a female. The agent may select a more formal or polite expression when the user is relatively old.

It is not always necessary for expert agents to interpret the user utterance using the full sentence search. A “beef” expert agent may be designed such that it always responds to the word “beef” or “meat” regardless of the whole sentence. Each expert agent may be implemented with a different method for interpreting the user utterance. A single expert agent may have more than one method to interpret the user utterance.

The character manager 2096 of the second processor 2084 may be combined with the total system manager 2090 of the first processor 2082. There may be various modifications to achieve the same functions. Combining or dividing the functional blocks depends on the design guide and the actual operation.

An action of a character such as “Speak” was described to be sent from a server to each character controller. The action, however, may be received by each agent controller, which sends it to each character controller via the total system manager 2090. In this method, the total system manager 2090 can detect all the situations occurring in the system. The total system manager 2090 can more easily realize an action of a character to “Speak” to all the other characters and make a character recognize the action of another character as the total system manager 2090 knows the frame names in which each character controller resides, the number of expert agents or characters and the positions of characters.

Embodiment 4

If a user wants to revisit in future a specific web site, he/she usually puts a bookmark on the URL of the web site. The number of bookmarks thus stored is easily increased as the user browses web sites. According to Embodiment 4, agents or characters help user find a desired web site easily.

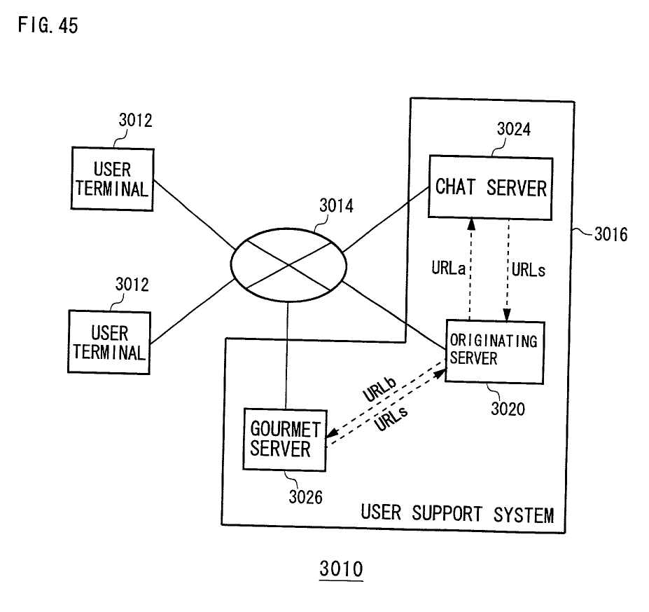

FIG. 45 shows the entire configuration of a network system 3010 including a user support system 3016 according to Embodiment 4. A user terminal 3012 and a user support system 3016 are connected via the Internet 3014.

The user support system 3016 comprises an originating server 3020, a chat server 3024 and a gourmet server 3026, which are connected to the Internet 3014. The originating server 3020 comprises an electronic user utterance collection created anticipating or assuming user utterance and an utterance identification block to specify the user utterance when it is inputted. The user utterance identification block is commonly referred to from other servers in the system, for example, the chat server 3024 and the gourmet server 3026. The chat server 3024 and the gourmet server 3026 comprise an electronic agent action collection created assuming the action of an agent to respond to the user utterance and a response block to make the agent respond to the user utterance, respectively. The servers have the response blocks independently within their nodes.

The originating server 3020, the chat server 3024 and the gourmet server 3026 are different network nodes so that the process to specify user utterance and the process to make an agent respond to the utterance can be conducted simultaneously in different nodes. Agents can be made into different nodes and the maintenance for each agent becomes easier. The system 3016 may be composed as a single unit to be implemented in a portal site. The servers, however, are included in different nodes. The originating server 3020 behaves as a portal server for the user terminal 3012.

A user utterance is first transmitted to the originating server 3020, which specifies the utterance referring to the user utterance collection. An agent which should respond to the utterance is specified and the response block executes a process for response. For example, an agent in the chat server 3024 responds to general greetings such as “Hello”. An agent in the gourmet server 3026 responds to meals, foodstuff and so on. Each expert agent supports to find information needed for the user out of huge amount of information by obtaining the needs of the user specified during the conversation with the user.

According to the present embodiment, when the user puts a bookmark on a web site he/she likes, the bookmark information is automatically classified into one of the folders prepared for specialized areas. For example, when the user puts a bookmark on a web site searched and presented to the user by the gourmet agent, the URL of the site is stored in a folder related to gourmet or a gourmet folder. The bookmark information is presented or displayed to the user such that it is classified in each folder.

The process in FIG. 45 is summarized as follows. A local agent implemented within the user terminal 3012 appears when the user initiates the user terminal 3012. The local agent waits for the first or initial utterance of the user. The initial utterance is sent to the originating server 3020 via the Internet 3014. The www browser in the user terminal 3012 displays a page in the originating server 3020.

The originating server 3020 is installed with a user utterance collection which holds expected user utterances. The initial utterance is searched in the user utterance collection so as to be identified. An expert agent suitable for the initial utterance is specified and the URL, which is shown as “URLa/URLb” in FIG. 45, of the specified specialized server is sent to the browser of the user terminal 3012. The user terminal 3012 displays the image corresponding to the page of the specialized server. The expert agent appears on the screen. Each specialized server includes an agent action collection for a respective expert agent and responds to the initial utterance and further utterance of the user, which is hereinafter referred to as a “general utterance”. The action of an agent is exemplified with an utterance hereinafter. The action, however, may include a gesture and other behavior, colors in the screen image, the change in texture, the search operation of the agent and other program processes to respond to the user.

When the user gives a new utterance or a general utterance to the expert agent, the utterance is sent to the originating server 3020. The originating server 3020 again specifies an expert agent suitable for the utterance and sends the URL of the specialized server to the user terminal 3012. A series of steps below is repeated.

1. specify the user utterance by the originating server 3020;

2. specify a specialized server to cope with the specified utterance;

3. respond to the user by the expert agent implemented in the specialized server;

4. encourage the user to input a new utterance.

In each cycle of the above process, the initial step is always conducted by the originating server 3020.

In the above process, the expert agent, by searching over the Internet, presents the user information needed by the user. When the user requests to register a bookmark on the web site having the presented information, a bookmark register provided in the originating server 3020 stores the URL of the web site in a folder corresponding to the specialized area of the agent.

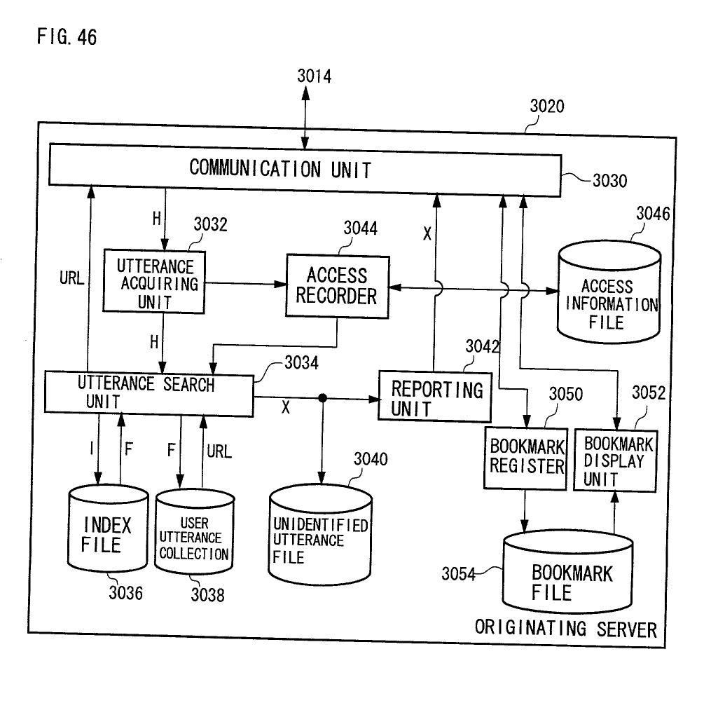

FIG. 46 shows the internal structure of the originating server 3020. Only the difference between FIG. 46 and FIG. 34 is now described.

The bookmark register 3050 stores in a bookmark file 3054 the URL of the web site upon request for the registration from the user. The bookmark information is classified and stored in one of the folders which is provided for the specialized area. A bookmark display unit 3052 displays the bookmark information stored in the bookmark file 3054 classified in the folders.

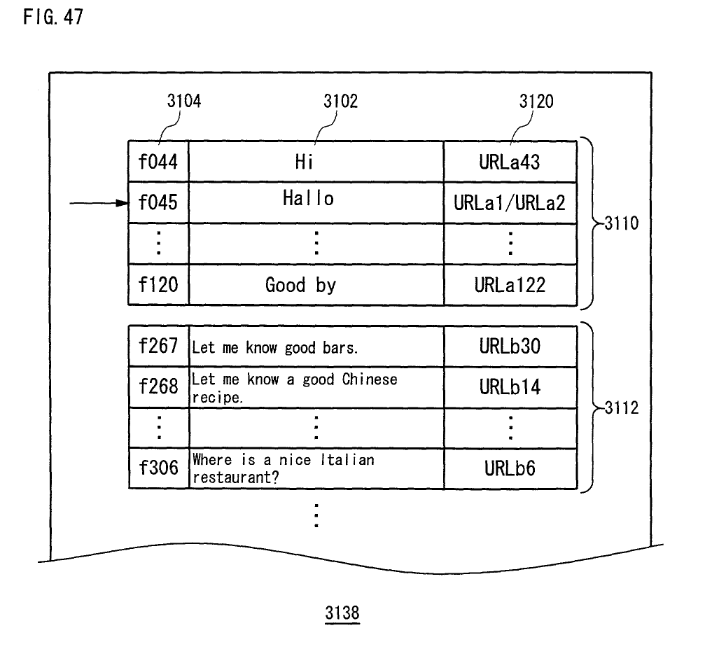

An index file 3036 is shown in FIG. 35 in Embodiment 3. A user utterance collection 3038 shown in FIG. 47 is almost the same as the one shown in FIG. 36 in Embodiment 3. In FIG. 47, however, files f267 and f306 relate to a restaurant or gourmet.

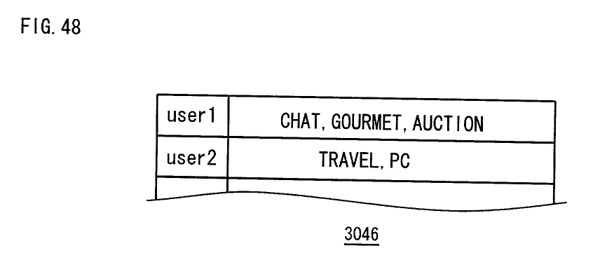

FIG. 48 illustrates the internal description of an access information file 3046. The access information file 3046 is almost the same as the one shown in FIG. 37. In FIG. 48, however, “recipe” is replaced by “gourmet”.

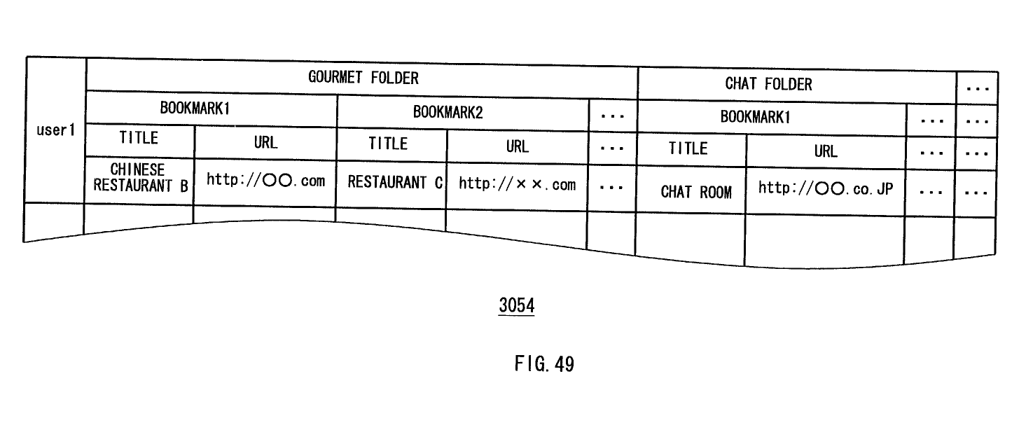

FIG. 49 shows the internal structure of the bookmark file 3054. The bookmark information registered by “user1” is classified and stored in “gourmet folder”, “chat folder” and so on. Each folder stores a plurality of bookmarks. “Gourmet folder”, for example, stores the URL “http://OO.com” of the web site “Chinese restaurant B” as bookmark 1 information and the URL “http://XX.com” of the web site “restaurant C” as bookmark 2 information.

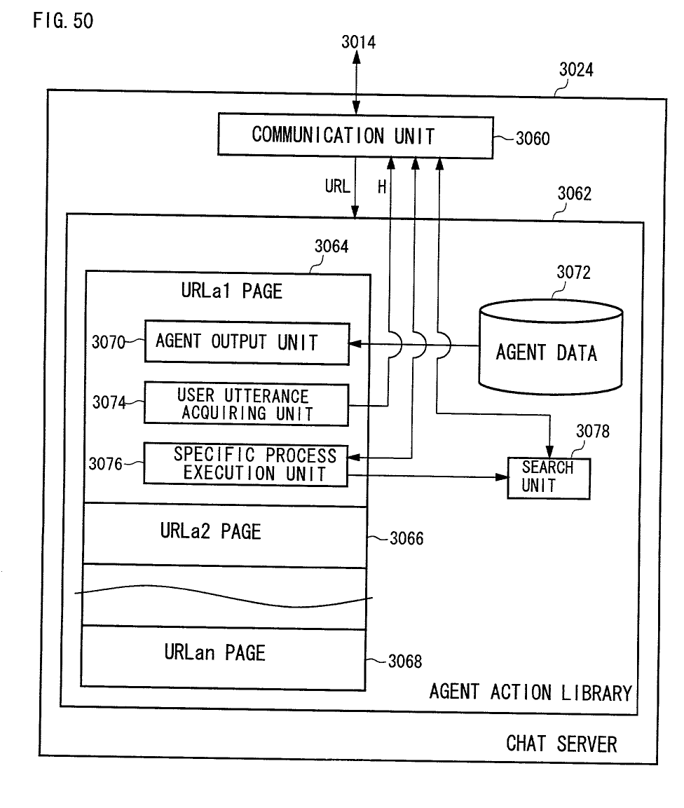

FIG. 50 shows the internal structure of the gourmet server 3026 as an example of specialized servers. A communication unit 3060 communicates with the user terminal 3012, the originating server 3020 and the like via the Internet 3014. The URL specified by the utterance search unit 3034 of the originating server 3020 is input to an agent action library 3062 via the communication unit 3060. The agent action library 3062 includes agent data 3072 which describes the expert agent utterance, image and behavior. Each URL specified by the utterance search unit 3034 has a page corresponding thereto.

In FIG. 50, the page 64 corresponding to the URLa1 is illustrated. The page 64 includes an agent output unit 3070, a user utterance acquiring unit 3074 and a specific process execution unit 3076. The agent output unit 3070 responds to the user utterance with the gourmet agent based on the agent data 3072. The specific process execution unit 3076 conducts processes other than response by utterance. The specific process or purpose execution unit 3076 may execute various programs. A search unit 3078 searches information requested by the user via the Internet 3014. For example, the utterance which leads the user to the page is “Teach me good restaurants in New York”, the gourmet agent searches for restaurant information via the Internet 3014 and presents the information to the user. The user utterance acquiring unit 3074 acquires general utterances of the user and transmits them to the originating server 3020, which specifies a specialized server again.

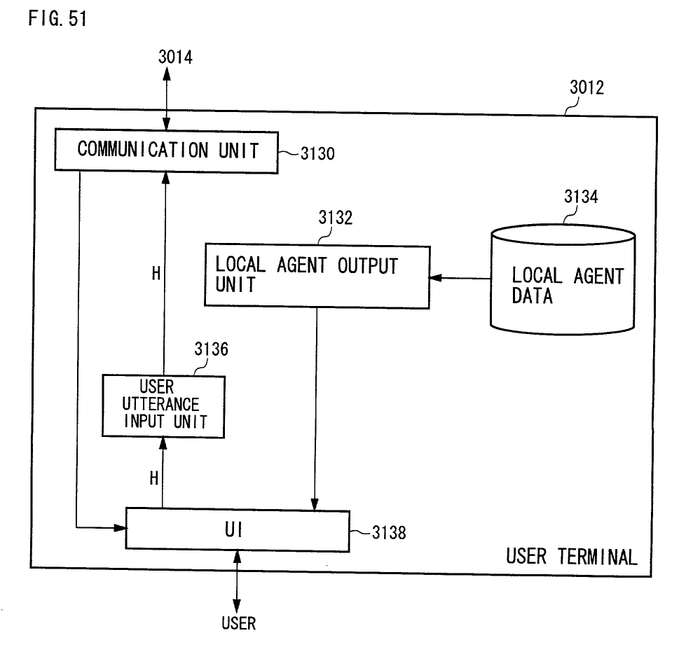

FIG. 51 shows the internal structure of the user terminal 3012. A communication unit 3130 communicates with the originating server 3020, the chat server 3024, the gourmet server 3026 and the like via the Internet 3014. A UI 3138 may be a keyboard, a mouse, a display apparatus and various data interface formats. A local agent output unit 3132 provides local agent data 3134 to the user via the UI 3138. The initial utterance and general utterances of the user are acquired by a user utterance input unit 3136 via the UI 3138. The acquired utterance is sent to the originating server 3020 via the communication unit 3130 and the Internet 3014.

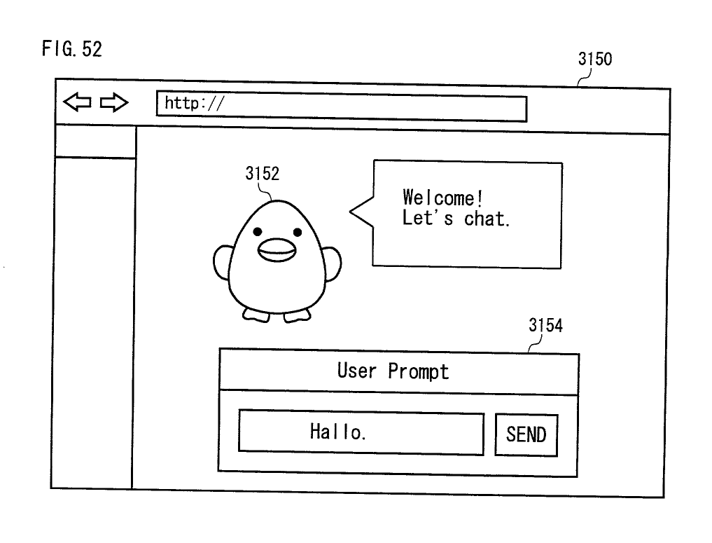

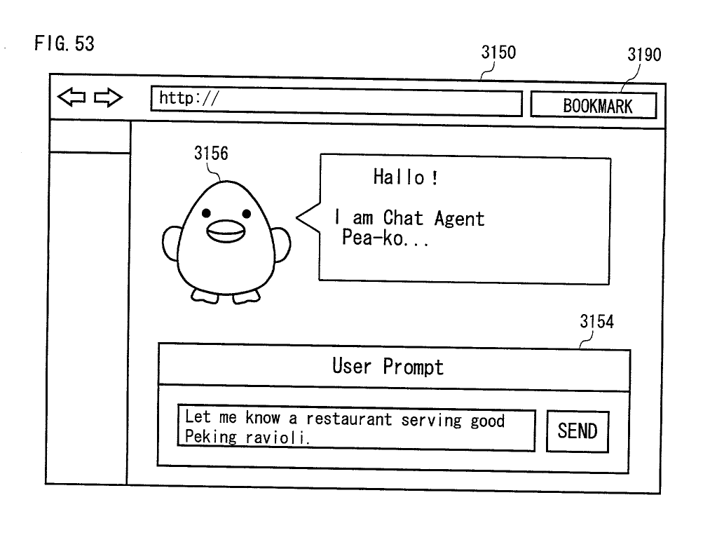

FIG. 52 illustrates a screen 3150 displayed when the user terminal 3012 is initiated. A local agent 3152 appears and says “Welcome! Let's chat”. The user inputs “Hello” in an input area 3154 and sends it. The input “Hello” is sent to the originating server 3020 as the initial utterance, from which the chat server 3024 as a specialized server is specified. The user terminal 3012 accesses a page in the chat server 3024.

FIG. 53 illustrates the screen 3150 displayed after the above process. Chat Agent 3156 is displayed. In the present embodiment, the local agent 3152 is the same as Chat Agent 3156 by appearance so that a seamless conversation continues. A bookmark button 3190 is displayed by the bookmark file 3054 on the screen. When the user pushes the bookmark button 3190, the bookmark information stored is displayed with the folders. Chat Agent 3156 speaks “Hello! I am Chat Agent Pea-ko . . . ”. The user inputs in the input area 3154 ” Let me know a restaurant serving good Peking ravioli”. The utterance is acquired by the originating server 3020 which identifies a page in the gourmet server 3026. The URL of the identified page is sent to the user terminal 3012, which accesses to the page.

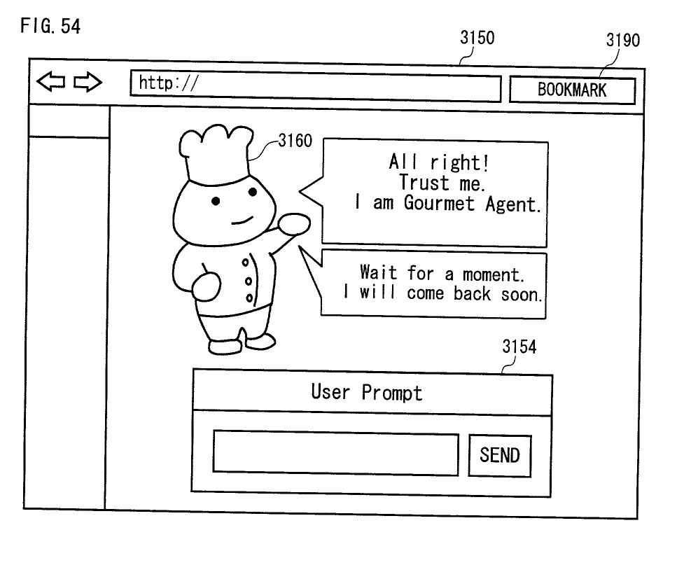

FIG. 54 illustrates the screen 3150 displayed after the above process. Gourmet Agent 3160 appears and speaks “All right! Trust me. I am Gourmet Agent.” The search unit 3078 searches over the web pages using a keyword “Peking ravioli”. The agent speaks “Wait for a moment. I will come back soon.” not to be silent and to let the user know the search process is in progress. When the search is finished, a page to display the search result is displayed.

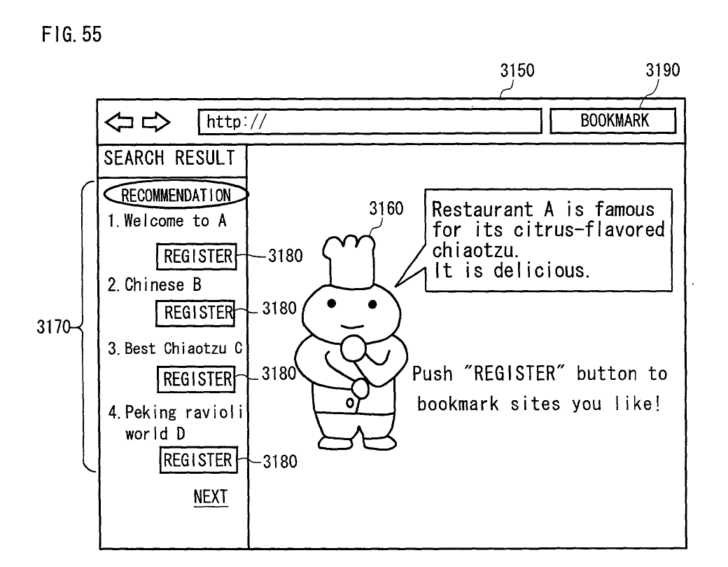

FIG. 55 illustrates the screen 3150 displaying the page for the search result. The titles 3170 of the web pages obtained by the search unit 3078 are displayed. Each title 3170 is linked to the web page so that the user can easily access thereto. When the user clicks a register button 3180, the corresponding URL of the web site is stored in the gourmet folder contained in the bookmark file 3054.

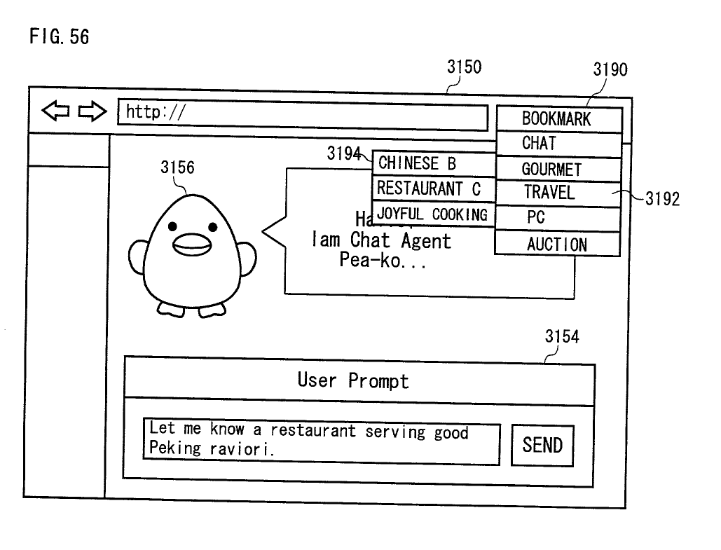

FIG. 56 illustrates the screen 3150 displaying the registered bookmark information. When the user clicks a bookmark button 3190, a folder list 3192 is displayed by the bookmark display unit 3052. When the user puts a cursor on the gourmet folder, the titles 3194 of the web sites stored in the gourmet folder appear. The user can access to the URL of the web site when the user clicks a title.

A few modifications of the present embodiment are as follows.

In the present embodiment, the utterance identification block is installed in the originating server 3020 and is commonly used by a plurality of servers. Each specialized server, however, may have its own independent utterance identification block and response block. In this configuration, each server can manage its own user utterance collection and agent action collection so that the management and maintenance of the agent become easier within the server. A core server to process all the utterances may be provided even in this configuration.

In the present embodiment, the images of the local agent 3152 and Chat Agent 3156 are made identical. Naturally, it is not necessary to match them. The local agent 3152 may not be installed in the user terminal 3012. Instead, an “opening agent” or the like which appears when the user terminal 3012 is initiated may be implemented in the originating server 3020.

In the present embodiment, the bookmark register 3050, the bookmark display unit 3052 and the bookmark file 3054 are provided in the originating server 3020. These units naturally may be implemented in other specialized servers or in the user terminal 3012.

In the present embodiment, each folder in the bookmark file 3054 corresponds to each specialized area of a specialized server. Naturally, folders may be classified on an arbitrary criterion. For example, the system may request the user to designate a plurality of folders and to suggest which folder to be associated with which kind of web sites. When a web site is requested by the user to be registered, the type of the web site may be analyzed referring to the user utterance collection to specify a specialized area. A bookmark is then put on the web site and is stored in the folder associated with the specified specialized area. According to this method, the bookmark information already stored in the user terminal 3012 may be reclassified.

The folders in the bookmark file 3054 may be prepared beforehand or may be generated or modified by adding new folders requested from the user or any expert agents. The bookmark information may be classified when it is stored upon request from the user or may be classified later as mentioned. As long as the bookmark information can be classified and stored to help the user revisit the web site he/she likes, many modifications for creating folders are available.

Embodiment 5

The whole network system including a user support system according to Embodiment 5 is the same as FIG. 45 of Embodiment 4.

The user support system according to Embodiment 5 requests the user to register the items of information he/she is interested in and therefore searches frequently. By this registration, search process can be immediately initiated when the user utterance relates to the information items. In this system, the search is also conducted even without the user utterance so that the search result can be presented immediately. User utterances to be a trigger to start the search or to display the search result are predefined to present the information timely to the user.

A character imitating a human or an animal is used to present the information to the user in such a manner that the character seems to perform the search spontaneously. By employing the character, even beginners of PCs or the like can feel relaxed. Each character is corresponded to each specialized area of information and the user can easily understand to which area the information now being processed belongs watching the character. Characters which are in charge of the areas the user is interested in and conducts frequent search often appear to chat with the user. The user intimately interacts with the characters.

Such characters may be registered as “favorite characters” so that the user can call them instantly. Favorite characters are so configured that the user can register the URLs of web sites he/she likes in areas related to the characters, which present renewal information of the web sites to the user. Each character stores the URLs of the web sites which fall within the specialized area the character is associated with. In this configuration, bookmarks can be classified according to specialized areas as the characters virtually work as folders for the bookmarks. The user does not need to confirm whether information is updated or not in the web sites as the character informs the user of the situation. The character may inform the situation periodically spontaneously or when the user utterance relates to the web sites.

The favorite characters may be raised by the user. A “character house” may be displayed on the screen in which the characters live. The attributes of the characters may change based on the attitude or behavior of the user on the characters. The characters may behave differently according to the attributes. The attributes may include “cheer”, which becomes larger when the user handles the character gently and becomes smaller when the user mishandles the character. A character with the “cheer” attribute being large may frequently conduct the search, whereas a character with small “cheer” attribute may stop working until the attribute is recovered. Such design of characters gives amusement to the user.

The major process flow of Embodiment 5 is almost the same as Embodiment 4 and the difference is described. The user utterance collection includes an additional utterance collection which contains expected utterances to trigger the search by expert agents.

When the initial utterance of the user is detected in the additional utterance collection, the process jumps to a page to conduct search and displays the search result. In the page, a process flow is written such that the search is performed based on the data the user registered beforehand and that the search result is presented to the user via the character. In another example, the situation whether the web site registered is updated or not is acquired and presented to the user via the character. In these examples, the process itself jumps to the page for the search. Alternately, an instruction to start search is sent to an expert agent so that the search process is performed as a background process. When the background process is performed, the conversation between the character and the user may be continued.

With regard to general utterances which follow the initial utterance, the process is almost the same as Embodiment 4. A series of process, however, is slightly different as follows.

1.specify the user utterance by the originating server 4020;

2.specify a specialized server to cope with the specified utterance;

3. respond to the user by the expert agent implemented in the specialized server;

4. perform information search and display the search result;

5. encourage the user to input a new utterance.

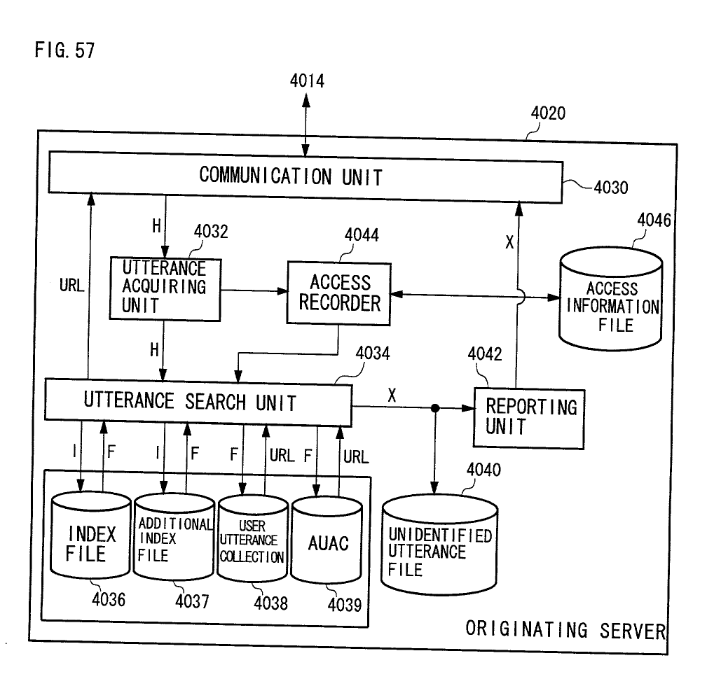

FIG. 57 shows the internal structure of the originating server 4020. Now only the difference from FIG. 46 is described.

Each utterance has one corresponding file within the user utterance collection 4038. The URL of a page to respond to the user utterance is described in each file. The content of the additional user utterance collection 4039 is included in the user utterance collection 4038 although they are separately shown in FIG. 57 for the convenience of understanding.

The URL detected in the user utterance collection 4038 or in the additional user utterance collection 4039 is transmitted to the browser of the user terminal 4012 via the communication unit 4030. The browser then connects to the designated specialized server containing the page.

The internal structure of the index file 4036 is the same as FIG. 35. The internal structure of the user utterance collection 4038 is the same as FIG. 47. The internal description of the access information file 4046 is the same as FIG. 48.

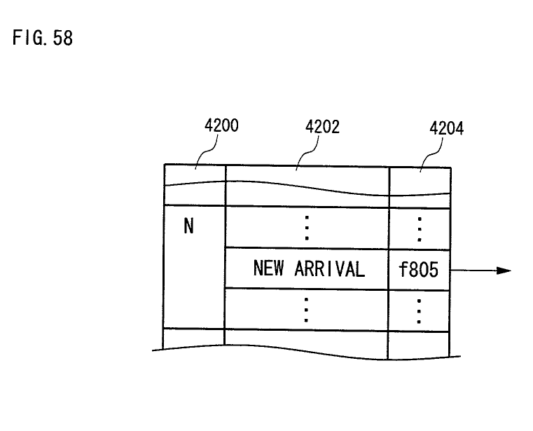

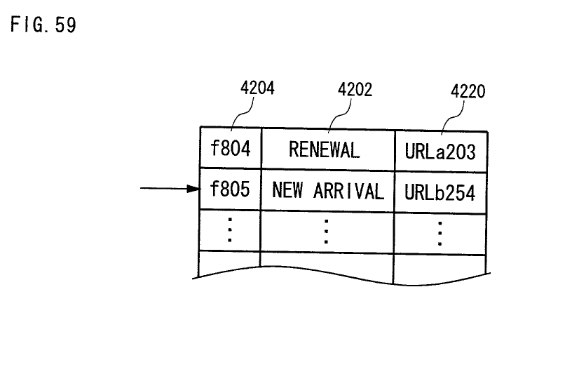

FIGS. 58 and 59 show the internal structure of an additional index file 4037 and the additional user utterance collection 4039, respectively. These components are included in the index file 4036 and the user utterance collection 4038, respectively, but they are shown as independent components. The additional index file 4037 comprises an alphabet column 4200, a user utterance column 4202 and a file name column 4204. User utterance is sorted in an alphabetic manner.

The additional user utterance collection 4039 comprises a file name column 4204, a user utterance column 4202 and a page column 4220 to indicate a specialized server to respond to the user. When the user utterance is “renewal”, the page of the responsible specialized server is “URLa203” and the combination of “renewal” and “URLa203” composes the file f804. The additional index file 4037 and the additional user utterance collection 4039 are linked through file names. For example, the utterance “new arrival” is contained in the file f805 in the additional index file 4037, which is in turn associated with the file f805 in the additional user utterance collection 4039.

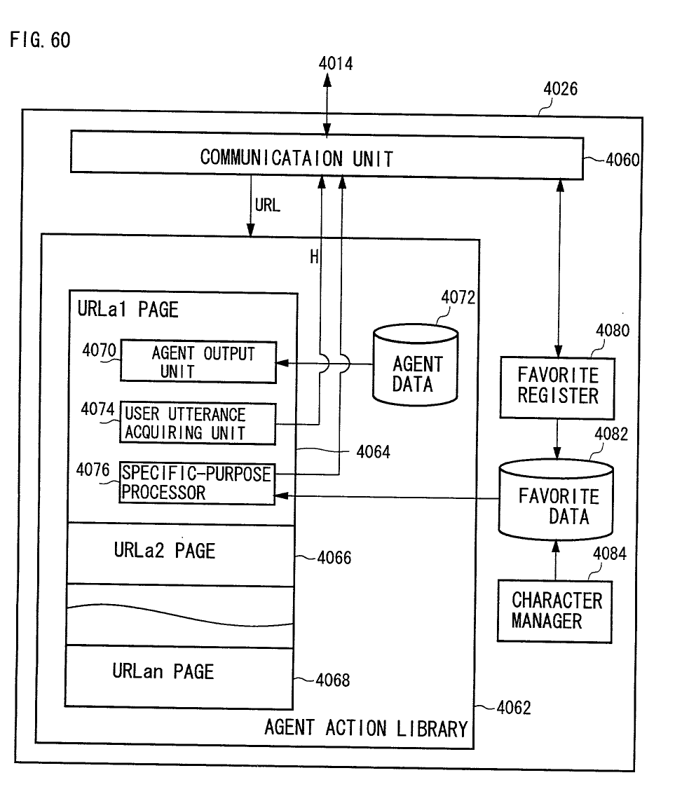

FIG. 60 shows the internal structure of the gourmet server 4026. Now only the difference from FIG. 50 is described.

The specific-purpose processor 4076 in the page 64 of URLa1 performs information search in addition to the counterpart in FIG. 50.

A favorite register 4080 registers the gourmet agent as a favorite data 4082 upon request from the user. The favorite register 4080 also registers the content of information the user wishes to search and the URLs of the web sites as the favorite data 4082 upon request. A character manager 4084 manages the attributes of characters and changes the values in accordance with the treatment of the characters by the user. The attributes are also stored as the favorite data 4082.

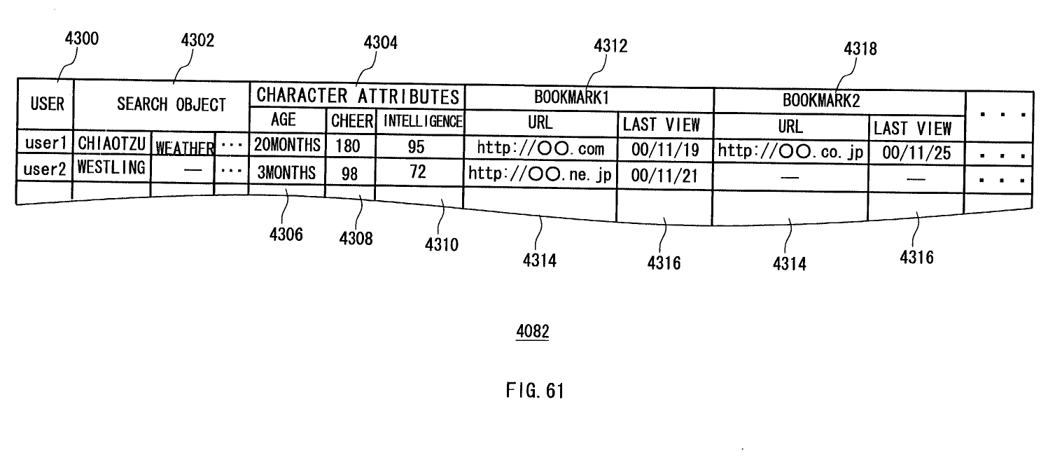

FIG. 61 shows the internal structure of the favorite data 4082. The favorite data 4082 is partitioned to a user name column 4300, a search object column 4302, a character attribute column 4304 and bookmark columns 4312, 4318. The search object column 4302 stores the content of information the user wishes to search. The character attribute column 4304 comprises an age column 4306, a cheer column 4308 and an intelligence column 4310, which are managed by the character manager 4084. These attributes are referred to when the characters are displayed on the screen. The bookmark columns store the bookmarks user puts on web sites. Each bookmark column contains a URL column 4314 and a last view column 4316 which indicates when the user made the last view on the URL.

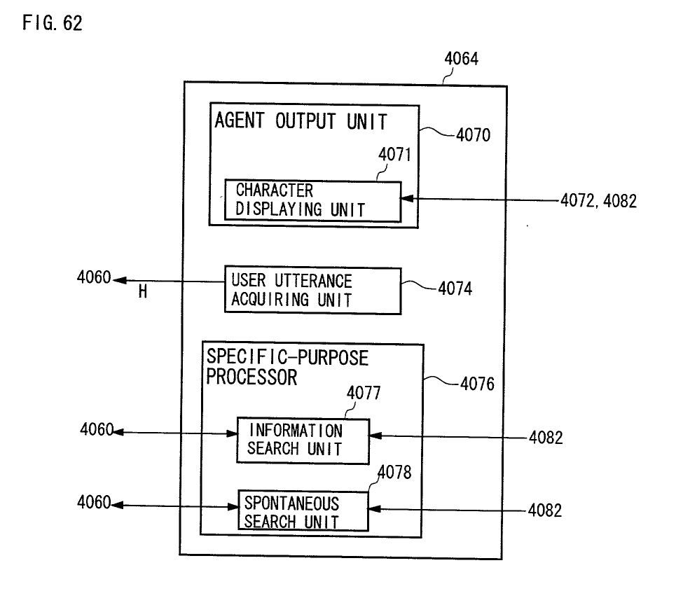

FIG. 62 shows the structure of a page stored in the agent action library 4062. The page is used for information search. A specific-purpose processor 4076 of the URLa2 page 66 contains an information search unit 4077 to search information requested by the user via the Internet 4014 and a spontaneous search unit 4078 to start the search process spontaneously. The information search unit 4077 and the spontaneous search unit 4078 acquires URL information and the content object stored in the favorite data 4082 when they start the search. The spontaneous search unit 4078 decides the search frequency referring to the attributes of a character stored in the favorite data 4082. The search result is presented to the user in the form of a character utterance by a character displaying unit 4071 in an agent output unit 4070.

The internal structure of the 4012 is the same as FIG. 51. The initial screen of the 4012 is the same as FIG. 52. The process shown in FIGS. 53 and 54 is also performed in this embodiment. In the process, it is assumed that the user inputs “Teach me a good restaurant famous for Peking ravioli”. The gourmet agent responds to the request and conducts the search. When the search is finished, the process jumps to a page to display the search result.

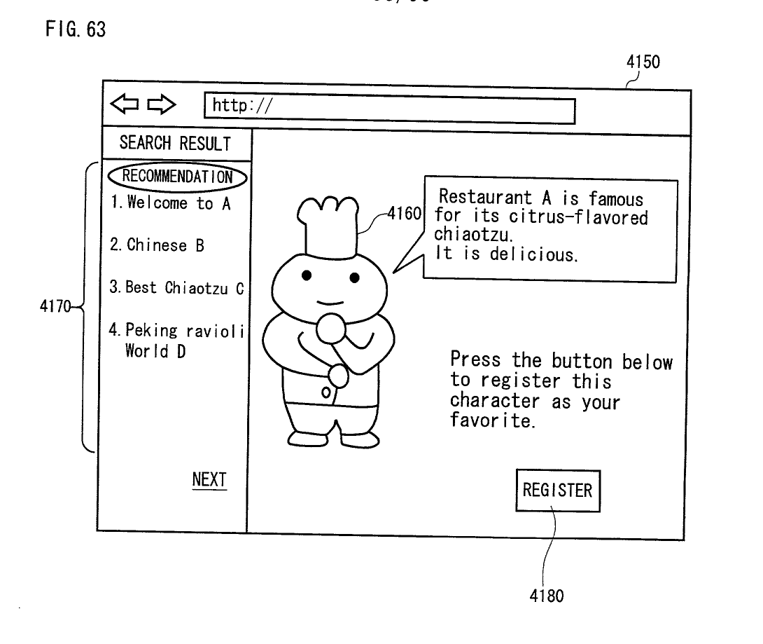

FIG. 63 shows the screen 4150 displayed based on the page. On the screen, the titles 4170 of the web pages acquired by the information search unit 4077 are displayed. The favorite register 4080 registers the gourmet agent as a favorite character when the user clicks a register button 4180.

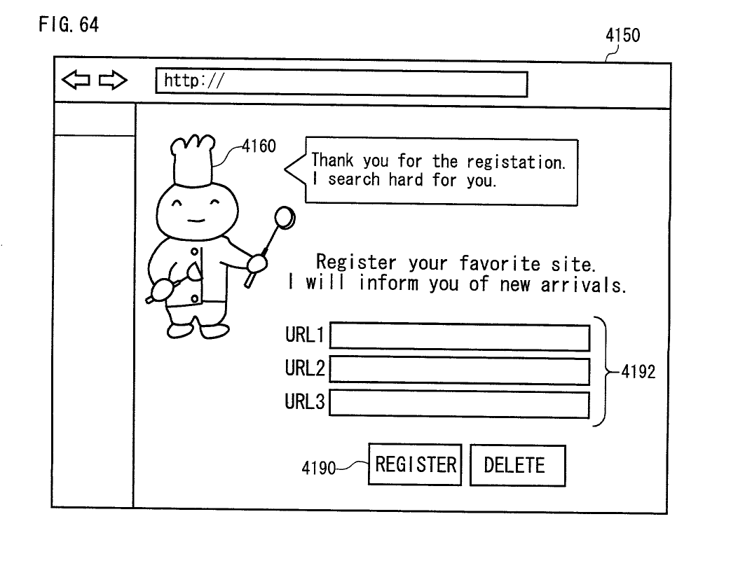

FIG. 64 shows the screen 4150 in which the favorite register 4080 accepts the registration of a bookmark from the user. A bookmark is registered in the favorite data 4082 when the user fills the URL of a web site he/she likes in a URL column 4192 and clicks a register button 4190. A bookmark may be registered when the user clicks a bookmark register button (not shown) while he/she views the web site.

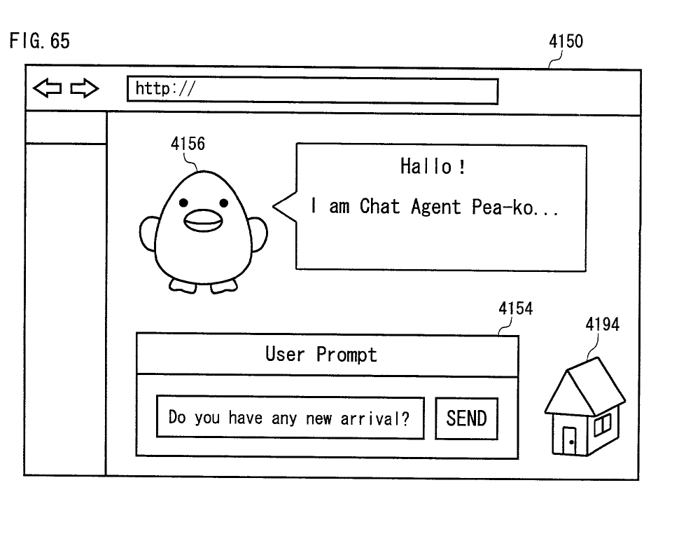

FIG. 65 shows the screen 4150 in which a favorite character registered by the user is displayed. A character house 4194 in which the favorite character lives is displayed. A search process is initiated when the user inputs “Do you have any arrivals?” as the user utterance is contained in the additional utterance collection.

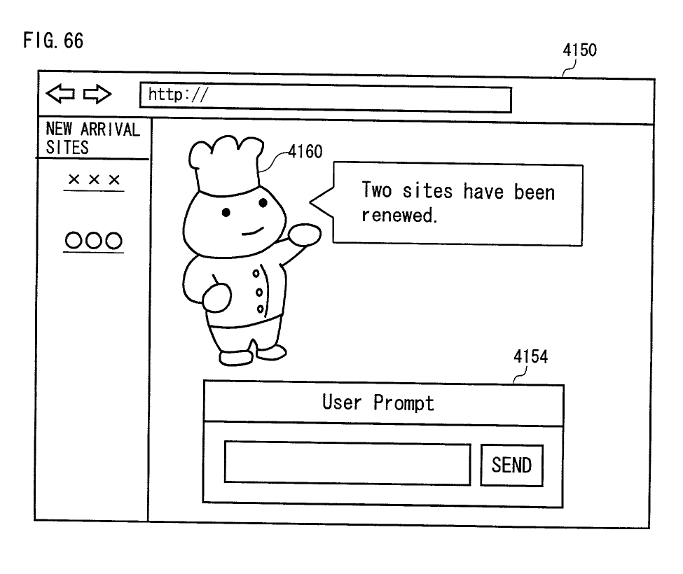

FIG. 66 shows the screen in which Gourmet Agent 4160 presents the search result. Gourmet Agent 4160 tells that two sites among those the user have registered have been renewed. The last view column 4316 in FIG. 61 is referred to in order to select sites which were renewed after the last view. Whether the registered web sites have been renewed or not may be checked when the user utterance relates to at least one of the web sites. Alternately, the registered web sites may be monitored periodically and renewed sites may be informed to the user when a user utterance is made.

In the present embodiment, the favorite register 4080, the favorite data 4082 and the character manager 4084 are implemented in a specialized server. These units, however, may be implemented in the originating server 4020 to be centrally managed thereby. The favorite data 4082 may be stored in the user terminal 4012. In this case, favorite characters may be designed as local agents to serve for the user in the user terminal 4012.

Although the present invention has been described by way of exemplary embodiments, it should be understood that many changes and substitutions may be made by those skilled in the art without departing from the spirit and the scope of the present invention which is defined only by the appended claims.

What is claimed is:

1. A user support apparatus comprising:
an agent storage which stores data of a first agent being dedicated to a user serving based on information of the user and data of a second agent being an expert of a specific area; and
an agent output comp which outputs the first and second agents derived from said data;
wherein the first agent, when the second agent selects information necessary to serve the user, presents a selection guide to the second agent based on the user information in a manner that the user can recognize the presentation of the guide.

2. The apparatus of claim 1, further comprising an interface through which the user inputs an instruction, wherein the second agent selects the information putting higher priority on the input instruction than the presented guide.

3. The apparatus of claim 1, wherein the second agent is so configured to respond to the first agent when the guide is presented, and wherein the first and second agents collaborate while having conversation.

4. The apparatus of claim 1, wherein the first and second agents start conversation when time elapsed for the selection of the information exceeds a predetermined value.

5. A user support apparatus comprising:
a front processor which works at a user interface level; and
a middle processor which handles and stores data to be presented to the user via the front processor;
wherein the front processor comprises an agent storage which stores data of a first agent being dedicated to the user serving based on information of the user and data of a second agent being an expert of a specific area, and
wherein the first and second agents are designed in said data so that the first agent, when the second agent requests the middle processor provide information necessary to serve the user, presents a selection guide to the second agent based on the user information in a manner that the user can recognize the presentation of the guide.

6. A user support apparatus comprising:
a front processor which works at a user interface level; and
a back processor which acquires data to be presented to the user from outside;
wherein the front processor comprises an agent storage which stores data of a first agent being dedicated to the user serving based on information of the user and data of a second agent being an expert of a specific area, and
wherein the first and second agents are designed in said data so that the first agent, when the second agent requests the back processor provide information necessary to serve the user, presents a selection guide to the second agent based on the user information in a manner that the user can recognize the presentation of the guide.

7. A user support apparatus comprising memory, program modules loaded on the memory and a CPU to execute the modules,
wherein the modules include functions of executing a first agent and a second agent,
the first agent being represented as a character to bridge the user and the apparatus and to serve the user in a user-dependent manner based on information of the user, and
the second agent being presented as a character to bridge the user and the apparatus and to serve the user for a specific area as an expert thereof, and
wherein the first agent, when the second agent selects information necessary to serve the user, presents a selection guide to the second agent based on the user information in a manner that the user can recognize the presentation of the guide.

8. A user support apparatus comprising:
an agent storage which stores data of a first agent and a second agent which bridge a user and the apparatus; and
an agent output unit which outputs the first and second agents derived from said data;
wherein the first and second agents are so configured to collaborate while having conversation recognizable from the user when the user requests a given service.

9. The apparatus of claim 8, wherein a process to optimize the service for the user is explicitly expressed in the conversation.

10. A user support apparatus comprising:
an agent controller which provides an agent to support a user;
an request analyzer which analyzes a request input from the user;
a response controller which presents to the agent controller necessary information for the requested service when the service has been judged processible and otherwise records the requested service as an unattained service.

11. The apparatus of claim 10, further comprising a communication unit which electronically reports the recorded unattained service to an administrator of the apparatus.

12. A user support apparatus comprising:
an agent controller which provides an agent to support a user;
a conversation data storage which stores conversation to be held between the user and the agent;
an request analyzer which analyzes a request input from the user;
a response controller which determines a response to the request based on result of the analysis; and
a log storage which stores log of the conversation actually held between the user and the agent;
wherein the response controller which presents to the agent controller necessary information, read from the conversation data storage, for the requested service when the service has been judged processible and otherwise records in the log storage the requested service as an unattained service.

13. A user support apparatus using a character comprising:
a first processor which conducts an agent level control and a second processor which conducts a character level control,
the first processor comprising:
a total system manager which provides a field for a plurality of agents to interact and manages the plurality of agents; and
a plurality of agent controllers each of which, through a character, acquires and interprets a user request so as to realize substantial functions of a respective agent; and
the second processor comprising:
a character manager which provides basic functions to visually represent interaction between the plurality of agents at the character level; and
a plurality of character controllers, each of which corresponds to one of the plurality of agent controllers and provides a series of character actions to the corresponding agent controller for use therein;
wherein interface between a horizontal function between the plurality of agents which is provided by the total manager and the character manager, and an individual function provided by the agent controller and the character controller, is predetermined for the plurality of agent controllers and the plurality of character controllers.

14. The apparatus of claim 13, wherein the predetermined interface absorbs difference of output formats of the plurality of characters and wherein the plurality of characters simultaneously appear on a single screen to interact.

15. The apparatus of claim 13, further comprising a region generator which corresponds to one of the plurality of agent controllers and which generates a window or a frame to display process result of the corresponding agent controller.

16. The apparatus of claim 13, wherein the plurality of agent controllers are segmented to a plurality of specific areas and wherein each of the plurality of agent controllers works for its specific area as an expert.

17. The apparatus of claim 13, wherein the apparatus is implemented as a client of a client-server system and wherein the substantial function of the agent controller at least is achieved by communication with the server.

18. The apparatus of claim 13, wherein the apparatus is implemented as a server of a client-server system and wherein the substantial function of the agent controller at least is achieved by communication with the client.

19. The apparatus of claim 13, wherein the character controller comprises an action file which describes actions to cope with the user request, the file being formed as a bundle of multiple pages, each page corresponding one of the actions.

20. The apparatus of claim 13, wherein the interaction includes conversation between the characters and wherein the total manager hands conversation data from one character to another character to realize the conversation.

21. The apparatus of claim 13, wherein the character manager acquires positional relation between the characters and initiates the interaction by changing the relation.

22. A client-server system using a character to support a user,
wherein the client comprises a first processor which conducts an agent level control and a second processor which conducts a character level control,
the first processor comprising:
a total system manager which manages a plurality of agents to achieve interaction therebetween; and
a plurality of agent controllers each of which, through a character, acquires and interprets a user request so as to realize substantial functions of a respective agent; and
the second processor comprising:
a character manager which represents the interaction between the plurality of agents at the character level; and
a plurality of character controllers, each of which corresponds to one of the plurality of agent controllers and provides a series of character actions to the corresponding agent controller for use therein;
wherein the server, collaborating with the client, interprets the user request and presents to the client information necessary to respond the request.

23. The system of claim 22, the server further comprises a control window manager which provides functions of the total manager and the character manager to the client.

24. The system of claim 22, wherein the server comprises a plurality of expert servers, each of which, for service in specific area, provides functions of the agent controller and the character controller to the client.

25. An user support method using a character, comprising:
conducting agent level control and conducting character level control,
wherein the agent level control provides a total management process to manage a plurality of agents to achieve interaction therebetween and a plurality of agent control processes, each of which responds to a user request via a respective character; and
wherein the character level control provides a character control process to represent the interaction between the agents at the character level and a plurality of character control processes, each of which corresponds to one of the agent control processes and provides a series of character actions to the corresponding agent control process; and
wherein interface between a horizontal function between the plurality of agents and a function individual to each agent is predetermined for the plurality of characters.

26. A user support apparatus comprising:
a user utterance identification block which comprises an electronic user utterance list holding expected utterance and identifies user utterance when it is inputted;
a plurality of response blocks, each of which makes one of agents, the agents being designed to have respective specific areas to work, respond to the inputted utterance when the utterance is included in a specific area assigned to the agent; and
a registration unit which stores in a storage region provided for each specific area a network address of an web site according to a request of the user.

27. The apparatus of claim 26, wherein the response block comprises a search unit which searches a web site having information desired by the user therein and wherein the registration unit stores the network address of the searched web site to a storage region assigned to the response block having the search unit which conducted the search.

28. The apparatus of claim 26, further comprising a display unit which presents registered web sites classified to the storage regions.

29. A network system comprising a plurality of user support apparatuses of claim 26 connected to the network as independent nodes, each of the apparatuses corresponding to one specific area, wherein the user utterance list and an agent action library of each apparatus are designed to concentrate on the area associated with the apparatus.

30. The system of claim 29, wherein the apparatus stores the respective response block therein while using the utterance identification block commonly with other apparatuses, the block being stored in one of the apparatuses.

31. A user support apparatus comprising:
a user utterance identification block which comprises an electronic user utterance list holding expected utterance and identifies utterance of the user when it is inputted; and
a response block which has an electronic agent action library to respond to the utterance and which makes an agent respond to the utterance;
a search item holder which acquires and holds in advance items of information the user wishes to search; and
a search unit which conducts search for the items;
wherein the utterance identification block further comprises an additional utterance list containing utterance for which the search unit is assumed to start the search, and
wherein the search unit starts the search when the utterance of the user is detected contained in the additional utterance list.

32. The apparatus of claim 31, wherein the search unit starts the search spontaneously without an instruction from the user.

33. The apparatus of claim 31, wherein each field of information is associated with a character and wherein the apparatus further comprises a character display unit which presents to the user result of the search in the form of utterance of a character which is associated with a field to which the search result is classified.

34. The apparatus of claim 33, wherein the search item holder further comprises a bookmark holder which stores a network address of a web site and wherein the search unit acquires update information of the web site.

35. The apparatus of claim 34, wherein the character display unit presents the user the update information in the form of utterance of a character when a web site which is classified to a field with which the character is associated.

36. The apparatus of claim 33, further comprising a character manager which manages attribute value of the character, which changes the value based on treatment of the character by the user and which changes behavior of the character based on the value.

37. The apparatus of claim 36, wherein the character manager changes frequency to check the update information of a web site which is classified to the field associated with the character, based on the value of the character.

38. A network system comprising a plurality of user support apparatuses of claim 31 connected to the network as independent nodes, each of the apparatuses corresponding to one specific area, wherein the user utterance list, the additional utterance list and the agent action library of each apparatus are designed to concentrate on the area associated to the apparatus.

39. The system of claim 38, wherein the apparatus stores the respective response block therein while using the utterance identification block commonly with other apparatuses, the block being stored in one of the apparatuses.
